(19) United States
(12) Patent Application Publication
(10) Pub. No.: US 2026/0220915 A1
(43) Pub. Date: Jul. 30, 2026

(54) INFORMATION PROCESSING APPARATUS, INFORMATION PROCESSING METHOD, RECORDING MEDIUM, INFERENCE DEVICE, AND CONTROL METHOD

(71) Applicant: Sony Semiconductor Solutions Corporation, Kanagawa (JP)

(72) Inventor: Masatoshi TAKAIRA, Kanagawa (JP)

(73) Assignee: Sony Semiconductor Solutions Corporation, Kanagawa (JP)

(21) Appl. No.: 19/157,377

(22) PCT Filed: Dec. 28, 2023
(86) PCT No.: PCT/JP2023/047186

§ 371 Date: Aug. 18, 2025

Related U.S. Application Data
(60) Provisional application No. 63/492,283, filed on Mar. 27, 2023.

(51) Int. Cl. G06V 10/764; G06N 5/04

(52) U.S. Cl. CPC G06V 10/764; G06N 5/04

(57) ABSTRACT

An information processing apparatus according to the present technology includes: a setting control processing unit that causes an inference device that performs inference processing using an AI model to set a designated model that is an AI model designated by a user; and an execution control processing unit that causes the inference device in a state in which the designated model has been set to execute inference processing using data designated by the user as inference target data.

### TECHNICAL FIELD

The present technology relates to an information processing apparatus and a method thereof, a recording medium, and an inference device and a control method, and particularly relates to a support technology when a user as an AI model developer tests an AI model.

### BACKGROUND ART

Various types of inference processing using an artificial intelligence (AI) model are widely performed. For example, as inference processing using image data as target data, inference processing or the like as object recognition processing for recognizing a category (person, dog, cat, car, or the like) of a subject is known, and as inference processing using sound data as target data, inference processing or the like as speaker identification processing for identifying each speaker with respect to a plurality of utterances is known.

Note that Patent Document 1 below can be cited as a related art. Patent Document 1 below discloses, as an inference device that performs inference processing using image data as target data, a sensor-integrated inference device in which a signal processing unit that performs inference processing is mounted in an image sensor in which a pixel array unit is formed.

### CITATION LIST

### Patent Document

Patent Document 1: International Publication No. 2023/090119

### SUMMARY OF THE INVENTION

### Problems to be Solved by the Invention

Here, regarding the AI model used for the inference device, a case where the AI model experimentally produced by the developer is tested for performance evaluation or the like will be considered. As a test of the AI model, in consideration of cost, it is conceivable to perform the test by a simulator without using an actual machine.

However, there is a possibility that sufficient accuracy cannot be obtained in the test by the simulator.

Furthermore, as the AI model, there is a case where a difference occurs in inference performance depending on characteristics of processing target data, and thus the test of the AI model should be performed with data having characteristics desired to be a target as a processing target.

For example, in a case where object recognition processing is performed on image data obtained by imaging the outdoors, characteristics of obtained image data are different between daytime and nighttime, and thus, as a test of the AI model, it is conceivable to perform a test using captured image data in daytime as processing target data and a test using captured image data in nighttime as processing target data.

Furthermore, when speaker identification processing is taken as an example, characteristics of sound data obtained in an environment of a sound collection target are different between an environment with a large amount of noise other than speech sound and an environment with a small amount of noise (in the former environment, there are many superimposed sounds with respect to the speech sound, and in the latter environment, there are few superimposed sounds), and therefore, as a test of the AI model, it is conceivable to perform a test using sound data in the former environment as processing target data and a test using sound data in the latter environment as processing target data.

As described above, the test of the AI model should be performed by simulating the assumed use environment of the user.

The present technology has been made in view of the above circumstances, and an object thereof is to improve test accuracy and reduce cost related to a test in a case where an AI model simulating an assumed use environment of a user is tested.

### Solutions to Problems

An information processing apparatus according to the present technology includes a setting control processing unit that causes an inference device that performs inference processing using an AI model to set a designated model that is an AI model designated by a user, and an execution control processing unit that causes the inference device in a state in which the designated model has been set to execute inference processing using data designated by the user as inference target data.

According to the above configuration it is possible to provide the user with an environment for testing the AI model using the inference device as an actual machine instead of a simulator as a test environment of the AI model. Furthermore, since the inference processing is executed by the inference device on the data designated by the user, in order to implement a test simulating an assumed use environment as a test of the AI model, it is sufficient if the user prepares data acquired in the use environment in advance and designates the data, and it is not necessary to actually place the inference device under the assumed use environment or an environment simulating the assumed use environment at the time of the test. Specifically, by adopting a method of inputting data designated by the user to the inference device, it is not necessary to prepare a sensing device such as an image sensor or a microphone for obtaining inference target data and perform sensing in the test environment. In a case where sensing for obtaining the inference target data is performed in the test environment, the sensing device and the inference device are placed in the assumed use environment or in the environment simulating the assumed use environment in order to implement the test simulating the assumed use environment, but since it is not necessary to perform sensing in the test environment by adopting the method using user-designated data as the inference target data as described above, it is not necessary to actually place the inference device in the assumed use environment or a simulated environment thereof at the time of the test. In the test of the AI model, it is not necessary to place the inference device in a specific environment such as the assumed use environment or the simulated environment thereof, so that cost reduction is achieved. Furthermore, in a case where a plurality of use environments is tested, it is not necessary to prepare an inference device for each use environment, so that cost reduction is also achieved in this respect.

Furthermore, an inference device according to the present technology includes an inference unit that performs inference processing using an AI model, and a control unit that causes a designated model, which is an AI model designated by a user and transmitted from an external apparatus, to be set as the AI model used by the inference unit, and causes the inference unit in a state in which the designated model has been set to execute inference processing using data designated by the user and transmitted from the external apparatus as inference target data.

Even with such an inference device, it is possible to provide the user with an environment for testing the AI model using the inference device as an actual machine instead of a simulator as a test environment of the AI model. Furthermore, since the inference processing is executed on the data designated by the user, in order to implement a test simulating an assumed use environment as a test of the AI model, it is sufficient if the user prepares data acquired in the use environment in advance and designates the data, and it is not necessary to actually place the inference device under the assumed use environment or an environment simulating the assumed use environment at the time of the test.

### BRIEF DESCRIPTION OF DRAWINGS

FIG. 1 is a block diagram illustrating a schematic configuration example of an information processing system as a premise in an embodiment.

FIG. 2 is an explanatory diagram of a method of registering an AI model and AI utilization software in an information processing apparatus as a cloud side.

FIG. 3 is a flowchart illustrating a processing example when the AI model and AI utilization software is registered in the information processing apparatus as a cloud side.

FIG. 4 is a flowchart illustrating a processing example corresponding to deployment of the AI model and AI utilization software.

FIG. 5 is a block diagram illustrating a hardware configuration example of an information processing apparatus as an embodiment.

FIG. 6 is a block diagram illustrating a configuration example of an imaging device as an embodiment.

FIG. 7 is an explanatory diagram of a structure example of an image sensor.

FIG. 8 is an explanatory diagram of an example of connection between a cloud and an edge.

FIG. 9 is an explanatory diagram of deployment using a container technology.

FIG. 10 is an explanatory diagram of a specific configuration example of a cluster constructed by a container engine and an orchestration tool.

FIG. 11 is an explanatory diagram of an example of a flow of processing related to AI model relearning.

FIG. 12 is a diagram illustrating an example of a login screen related to a marketplace.

FIG. 13 is a diagram illustrating an example of a developer screen related to the marketplace.

FIG. 14 is a diagram illustrating an example of a user screen related to the marketplace.

FIG. 15 is a block diagram illustrating a configuration example of a model test system as an embodiment.

FIG. 16 is a block diagram illustrating a configuration example of an inference device as an embodiment.

FIG. 17 is a functional block diagram for describing a function related to a test of an AI model as an embodiment.

FIG. 18 is a diagram illustrating an example of a setting screen in the embodiment.

FIG. 19 is a diagram illustrating an example of a test result screen in the embodiment.

FIG. 20 is a flowchart illustrating an example of a series of processing corresponding to processing from a test execution instruction to display of a test result.

FIG. 21 is a flowchart illustrating an example of processing related to display control according to an operation of changing a threshold of likelihood.

### MODE FOR CARRYING OUT THE INVENTION

Hereinafter, embodiments according to the present technology will be described in the following order with reference to the accompanying drawings.
<1. Example of Information Processing System as Premise>
(1-1. Overall System Configuration)
(1-2. Registration of AI Model and AI Utilization Software)
(1-3. Deployment of AI Model and AI Utilization Software)
(1-4. Configuration of Information Processing Apparatus)
(1-5. Configuration of Imaging Device)
(1-6. Sensor Structure)
(1-7. Connection between Cloud and Edge)
(1-8. Deployment Using Container Technology)
(1-9. Flow of Processing Related to AI Model Relearning)
(1-10. Screen Example of Marketplace)
<2. AI Model Test as Embodiment>
(2-1. System Configuration Example)
(2-2. Configuration Example of Inference Device)
(2-3. Example of AI Model Test Method)
(2-4. Processing Procedure)
<3. Modifications>
<4. Summary of Embodiment>
<5. Present Technology>

### 1. Example of Information Processing System as Premise

### (1-1. Overall System Configuration)

First, before describing a test method of an artificial intelligence (AI) model as an embodiment, an information processing system SY as a premise in the embodiment will be described. In the embodiment, a test of an AI model is performed with an AI model handled by the information processing system SY as a test target.

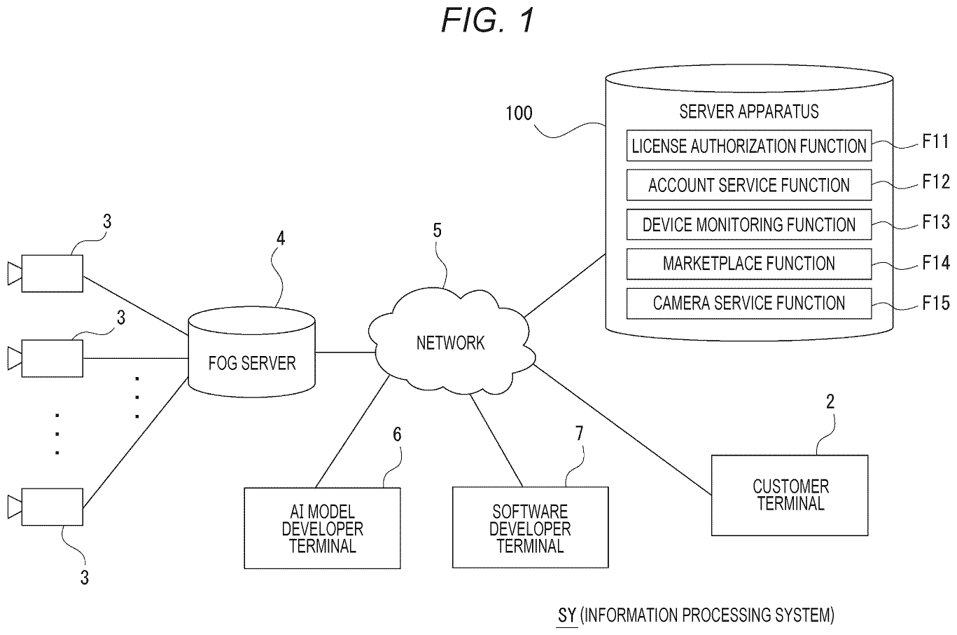

FIG. 1 is a block diagram illustrating a schematic configuration example of an information processing system SY.

As illustrated, the information processing system SY includes a server apparatus 100, one or a plurality of customer terminals 2, a plurality of cameras 3, a fog server 4, an AI model developer terminal 6, and a software developer terminal 7. In the present example, the server apparatus 100 is configured to be able to perform mutual communication with the customer terminal 2, the fog server 4, the AI model developer terminal 6, and the software developer terminal 7 via a network 5 such as the Internet.

The server apparatus 100, the customer terminal 2, the fog server 4, the AI model developer terminal 6, and the software developer terminal 7 are configured as an information processing apparatus including a microcomputer including a central processing unit (CPU), a read only memory (ROM), and a random access memory (RAM). For example, as a device form of the customer terminal 2, the AI model developer terminal 6, and the software developer terminal 7, a device form such as a personal computer (PC), a smartphone, or a tablet terminal are conceivable.

Here, the customer terminal 2 is an information processing apparatus assumed to be used by a customer who is a recipient of a service using the information processing system SY. Furthermore, the server apparatus 100 is an information processing apparatus assumed to be used by a service provider.

Each camera 3 includes, for example, an image sensor such as a charge coupled device (CCD) type image sensor or a complementary metal oxide semiconductor (CMOS) type image sensor, and images a subject to obtain image data (captured image data) as digital data. Furthermore, as will be described later, each camera 3 also has a function of performing inference processing such as image recognition processing using an AI model for a captured image.

Each camera 3 is configured to be capable of communicating data with the fog server 4, and is capable of transmitting various data such as processing result information indicating a result of image processing using the AI model to the fog server 4 and receiving various data from the fog server 4, for example.

Hereinafter, inference processing using the AI model is referred to as “AI processing”.

The information processing system SY illustrated in FIG. 1 is assumed to be used such that the fog server 4 or the server apparatus 100 generates analysis information of a subject on the basis of processing result information obtained by AI processing of each camera 3 and allows a system user (service receiver) as a customer to browse the generated analysis information via the customer terminal 2.

In this case, as various uses of each camera 3, various uses of surveillance cameras can be considered. Examples of the uses include the uses as a surveillance camera for monitoring indoors such as a store, an office, or a house, a surveillance camera (including a traffic surveillance camera and the like) for monitoring outdoor such as a parking lot or a street, a surveillance camera for a production line of factory automation (FA) or industrial automation (IA), and a surveillance camera for monitoring the inside or outside of a vehicle.

For example, in a case of the use as a surveillance camera for a store, it is conceivable to arrange a plurality of cameras 3 at predetermined positions in the store so as to allow the system user to check demographics (gender, age group, or the like) of in-store customers, customer actions (flow line) within the store, and the like. In this case, it is conceivable to generate, as the above-described analysis information, information regarding the demographics of in-store customers, information regarding the flow line in the store, information regarding a congestion status at a checkout (for example, information regarding a waiting time at the checkout), and the like.

Alternatively, in a case where the camera 3 is used as a traffic surveillance camera, it is conceivable to arrange each camera 3 at a position near a road so as to allow the user to recognize information such as a license number (vehicle number), a vehicle color, a vehicle type, and the like regarding a passing vehicle, and in this case, it is conceivable to generate, as the above-described analysis information, information such as the license number, the vehicle color, the vehicle type, and the like.

Furthermore, in a case where the traffic surveillance camera is used in a parking lot, it is conceivable to arrange the camera so as to be able to monitor each parked vehicle, monitor whether or not there is a suspicious person acting suspiciously around each vehicle, and in a case where there is a suspicious person, make a notification of a fact that there is a suspicious person, an attribute (gender, age group, clothes, or the like) of the suspicious person, and the like.

Moreover, it is also conceivable to monitor a street or an available space in the parking lot and notify the user of a place of the available parking space or the like.

In a case of the use as a surveillance camera for a store as described above, the fog server 4 is assumed to be arranged in a store being monitored together with each camera 3, that is, arranged for each object being monitored, for example. Providing the fog server 4 for each object being monitored such as a store as described above eliminates the need for the server apparatus 100 to directly receive transmission data from the plurality of cameras 3 installed for the objects being monitored, which allows a reduction in processing load on the server apparatus 100.

Note that, in a case where there is a plurality of stores being monitored and all the stores belong to the same corporate group, one fog server 4 may be provided for the plurality of stores rather than being provided for each store. That is, the present technology is not limited to the configuration where one fog server 4 is provided for each object being monitored, and one fog server 4 can be provided for a plurality of objects being monitored.

Note that, in a case where the function of the fog server 4 can be provided to the server apparatus 100 or each camera 3 because the server apparatus 100 or each camera 3 has processing capability, the fog server 4 may be omitted in the information processing system SY, each camera 3 may be directly connected to the network 5, and the server apparatus 100 may directly receive transmission data from the plurality of cameras 3.

The server apparatus 100 is an information processing apparatus having a function of performing overall control of the information processing system SY.

As illustrated in the drawing, the server apparatus 100 has a license authorization function F11, an account service function F12, a device monitoring function F13, a marketplace function F14, and a camera service function F15 as functions related to management of the information processing system SY.

The license authorization function F11 is a function of performing processing related to various types of authentication. Specifically, in the license authorization function F11, processing related to device authentication of each camera 3 and processing related to authentication of each of the AI model, software, and firmware used in the camera 3 are performed.

Here, the above software means software necessary for appropriately implementing the image processing using the AI model in the camera 3.

In order to appropriately perform the AI processing based on the captured image and transmit the result of the AI processing to the fog server 4 or the server apparatus 100 in an appropriate format, it is required to control data input to the AI model and appropriately process output data of the AI model. The above software is software including peripheral processing necessary for appropriately implementing image processing using the AI model. Such software can be rephrased as software for implementing a desired function using an AI model, and is thus hereinafter referred to as “AI utilization software”.

Note that the AI utilization software is not limited to one that uses only one AI model, and one that uses two or more AI models is also conceivable. For example, there may be AI utilization software having a flow of processing in which an image processing result (image data) obtained by an AI model that executes AI processing with a captured image as input data is input to another AI model to execute second AI processing.

In the license authorization function F11, for authentication of the camera 3, in a case where the camera 3 is connected to the camera 3 via the network 5, processing of issuing a device ID for each camera 3 is performed.

Furthermore, regarding the authentication of the AI model and the software, processing of issuing a unique ID (AI model ID, software ID) is performed for each of the AI model and the AI utilization software for which registration application has been made from the AI model developer terminal 6 and the software developer terminal 7.

Furthermore, in the license authorization function F11, processing of issuing various keys, certificates, and the like for enabling secure communication between the camera 3, the AI model developer terminal 6, and the software developer terminal 7 and the server apparatus 100, to a manufacturer of the camera 3 (particularly, a manufacturer of the image sensor 30 as described later), an AI model developer, and a software developer is performed, and processing for stopping or updating certification validity is also performed.

Moreover, in the license authorization function F11, in a case where user registration (registration of account information accompanied by issuance of a user ID) for a customer is performed by the account service function F12 described below, processing of associating the camera 3 (the device ID) purchased by the customer with the user ID is also performed.

The account service function F12 is a function of generating and managing account information of the user. The account service function F12 receives input of user information, and generates account information on the basis of the input user information (generates account information including at least a user ID and password information).

Furthermore, in the account service function F12, registration processing (registration of account information) for the AI model developer and the developer of the AI utilization software (hereinafter, also abbreviated as “software developer”) is also performed.

The device monitoring function F13 is a function of performing processing for monitoring the use state of the camera 3. For example, various elements related to the use state of the camera 3 such as the use place of the camera 3, the output frequency of output data of the AI processing, and the free space of the memory used for the AI processing are monitored.

The marketplace function F14 is a function for selling the AI model and the AI utilization software. For example, the user can purchase the AI utilization software and the AI model used by the AI utilization software via a sales WEB site (sales site) provided by the marketplace function F14. Furthermore, the software developer can purchase the AI model for creating the AI utilization software via the sales site described above.

The camera service function F15 is a function for providing a customer with a service related to use of the camera 3.

As one of the camera service functions F15, for example, a function related to generation of the analysis information described above can be exemplified. That is, it is a function of generating analysis information of a subject on the basis of processing result information of AI processing in the camera 3, and performing processing for causing the customer to browse the generated analysis information via the customer terminal 2.

Furthermore, in the present example, the camera service function F15 includes an imaging setting search function. Specifically, this imaging setting search function is a function of acquiring processing result information indicating a result of AI processing from the camera 3, and searching for imaging setting information of the camera 3 using AI on the basis of the acquired processing result information. Here, the imaging setting information broadly means setting information related to an imaging operation for obtaining a captured image. Specifically, it widely includes optical settings such as a focus and a diaphragm, settings related to a readout operation of a captured image signal such as a frame rate, an exposure time, and a gain, and settings related to image signal processing on the read captured image signal such as gamma correction processing, noise reduction processing, and super-resolution processing.

Furthermore, the camera service function F15 also includes an AI model search function. This AI model search function is a function of acquiring processing result information indicating a result of AI processing from the camera 3, and searching for an optimal AI model used for AI processing in the camera 3 using AI on the basis of the acquired processing result information. The search for the AI model here means, for example, processing of optimizing various processing parameters such as a weight coefficient, setting information (for example, information of a kernel size is included) related to a neural network structure, and the like in a case where the AI processing is implemented by a convolutional neural network (CNN) including a convolution operation, and the like.

Furthermore, the camera service function F15 also includes a relearning function (retraining function) of the AI model.

For example, the AI model relearned using a dark image from the camera 3 arranged in the store is set in the camera 3, whereby the image recognition rate and the like for the image captured in the dark place can be improved. Furthermore, the AI model relearned using a bright image from the camera 3 arranged outside the store is set in the camera 3, whereby the image recognition rate and the like for the image captured in the bright place can be improved.

That is, the user can always obtain optimized processing result information by redeploying the retrained AI model to the camera 3.

Note that the relearning processing of the AI model may be selected as an option by the customer on the marketplace, for example.

By having the imaging setting search function and the AI model search function as described above, for example, it is possible to perform imaging setting that makes a processing result of AI processing such as image recognition favorable, and to perform AI processing by an appropriate AI model according to an actual use environment.

Here, in the above description, the configuration in which the license authorization function F11, the account service function F12, the device monitoring function F13, the marketplace function F14, and the camera service function F15 are implemented by the server apparatus 100 alone has been exemplified, but these functions may be shared and implemented by a plurality of information processing apparatuses. For example, it is conceivable that each of the above-described functions is performed by one information processing apparatus. Alternatively, a plurality of information processing apparatuses may share and perform a single function among the above-described functions.

In FIG. 1, the AI model developer terminal 6 is an information processing apparatus used by a developer of an AI model (hereinafter referred to as “AI model developer”). In the present embodiment, the AI model is tested mainly by the AI model developer. Specifically, in the present embodiment, it is assumed that the AI model developer performs a performance test on the AI model developed by the AI model developer.

The software developer terminal 7 is an information processing apparatus used by a developer of AI utilization software.

### (1-2. Registration of AI Model and AI Utilization Software)

As understood from the above description, in the information processing system SY of the embodiment, the camera 3 performs image processing using an AI model and AI utilization software, and the server apparatus 100 implements advanced application functions such as various analysis functions by using result information of image processing on the camera 3 side.

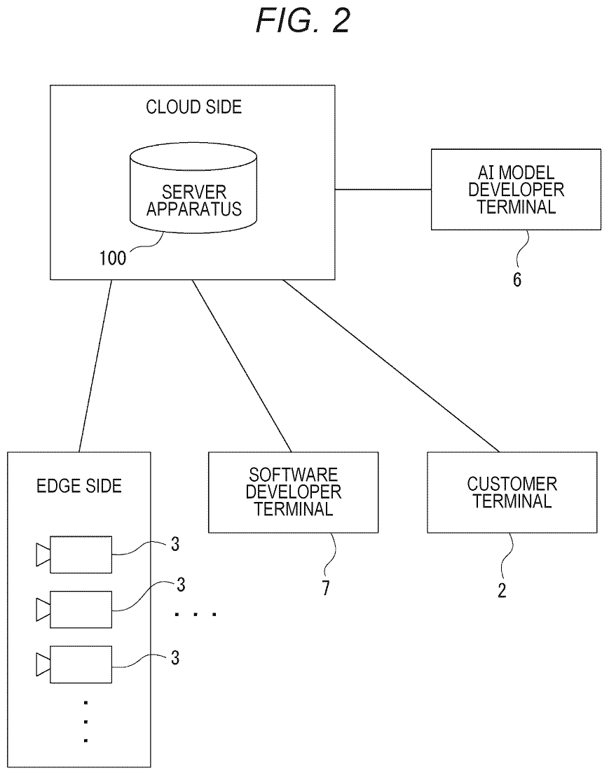

Here, an example of a method of registering the AI model and the AI utilization software in the server apparatus 100 (or including the fog server 4) as the cloud side will be described with reference to FIG. 2.

Note that, although illustration of the fog server 4 is omitted in FIG. 2, the fog server 4 may bear a part of functions on the cloud side, or may bear a part of functions on the edge side (camera 3 side).

On the cloud side, for example, a learning data set for performing learning by AI is prepared in the server apparatus 100. The AI model developer communicates with the server apparatus 100 using the AI model developer terminal 6, and downloads these learning data sets. At this time, the learning data set may be provided for a fee. In that case, the learning data set can be sold to the AI model developer by the above-described marketplace function F14 prepared as a cloud-side function.

After developing the AI model using the learning data set, the AI model developer registers the developed AI model in the marketplace (sales site provided by the marketplace function F14) using the AI model developer terminal 6. At this time, an incentive may be paid to the AI model developer according to download of the AI model.

Furthermore, the software developer downloads the AI model from the marketplace using the software developer terminal 7, and develops the AI utilization software. At this time, as described above, an incentive may be paid to the AI model developer.

The software developer registers the developed AI utilization software in the marketplace using the software developer terminal 7. In this way, an incentive may be paid to the software developer when the AI utilization software registered in the marketplace is downloaded.

Note that, in the marketplace (server apparatus 100), a correspondence relationship between the AI utilization software registered by the software developer and the AI model used by the AI utilization software is managed.

The customer can purchase the AI utilization software and the AI model used by the AI utilization software from the marketplace using the customer terminal 2. An incentive may be paid to the AI model developer according to the purchase (download).

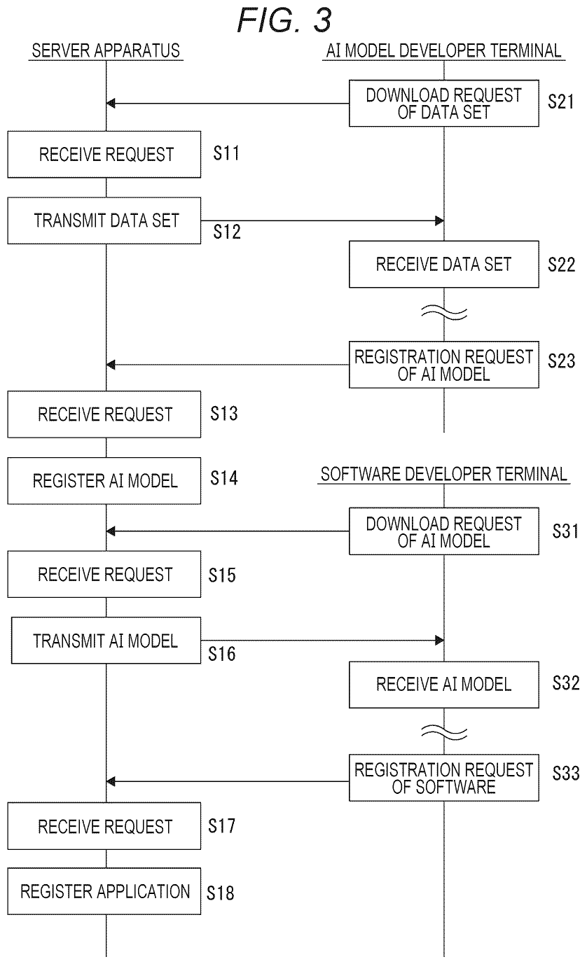

For confirmation, the flow of the above-described processing is illustrated in the flowchart of FIG. 3.

In FIG. 3, in step S21, the AI model developer terminal 6 transmits a download request of the data set (learning data set) to the server apparatus 100. This download request is made in response to, for example, the AI model developer browsing a list of data sets registered in the marketplace using the AI model developer terminal 6 having a display unit including a liquid crystal display (LCD), an organic electro luminescence (EL) panel, or the like, and selecting a desired data set.

After receiving the download request in step S11, the server apparatus 100 transmits the data set requested in step S12 to the AI model developer terminal 6.

The AI model developer terminal 6 receives the data set in step S22. Thus, the AI model developer can develop the AI model using the data set.

After the AI model developer finishes developing the AI model, when the AI model developer performs an operation for registering the developed AI model in the marketplace (for example, a name of an AI model, an address at which the AI model is placed, or the like is designated), the AI model developer terminal 6 transmits a registration request of the AI model in the marketplace to the server apparatus 100 in step S23.

The server apparatus 100 receives the registration request in step S13, and performs the AI model registration processing in step S14. Thus, for example, the AI model can be displayed on the marketplace. Thus, a user other than the AI model developer can download the AI model from the marketplace.

For example, a software developer who intends to develop AI utilization software browses a list of AI models registered in the marketplace using the software developer terminal 7. The software developer terminal 7 transmits a download request of the AI model selected in step S31 to the server apparatus 100 according to the operation (for example, an operation of selecting one of AI models on the marketplace) of the software developer.

The server apparatus 100 receives the request in step S15, and transmits the AI model to the software developer terminal 7 in step S16.

The software developer terminal 7 receives the AI model in step S32. Thus, the software developer can develop the AI utilization software using the AI model.

When the software developer performs an operation (for example, an operation of designating the name of the AI utilization software, the address at which the AI model is placed, and the like) for registering the AI utilization software in the marketplace after completing the development of the AI utilization software, the software developer terminal 7 transmits a registration request of the AI utilization software to the server apparatus 100 in step S33.

The server apparatus 100 receives the registration request in step S17, and registers the AI utilization software in step S18. Thus, for example, the AI utilization software can be displayed on the marketplace, and as a result, the customer can select and download the AI utilization software (and the AI model used by the AI utilization software) on the marketplace.

Here, when causing the camera 3 to use the purchased AI utilization software and AI model, the customer makes a request for causing the server apparatus 100 to install the AI utilization software and the AI model in a usable state in the camera 3.

Hereinafter, causing the camera 3 to install the AI utilization software and the AI model in a usable state as described above is referred to as “deployment”.

When the purchased AI utilization software and the AI model are deployed in the camera 3, processing using the AI model can be performed in the camera 3, and not only an image can be captured, but also detection of an in-store customer, detection of a vehicle, and the like using the AI model can be performed.

### (1-3. Deployment of AI Model and AI Utilization Software)

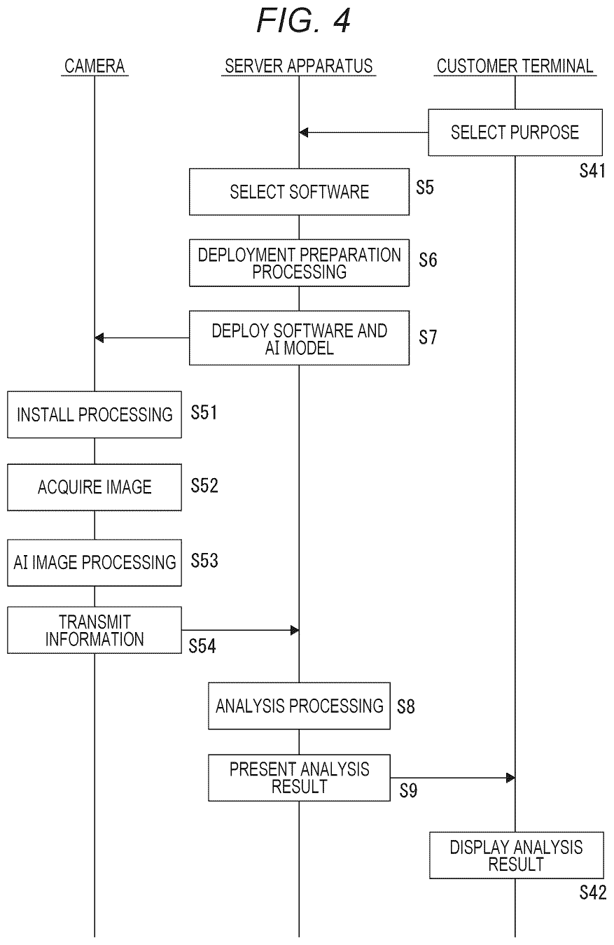

For confirmation, an example of processing corresponding to deployment of the AI model and the AI utilization software will be described with reference to the flowchart illustrated in FIG. 4.

First, in step S41, in the customer terminal 2, the purpose is selected by the customer who intends to use the AI utilization software. The purpose information indicating the selected purpose is transmitted to the server apparatus 100.

On the basis of the received purpose information, the server apparatus 100 selects the AI utilization software according to the purpose in step S5, and performs preparation processing (deployment preparation processing) for deploying the AI utilization software and the AI model to each device in step S6.

In the deployment preparation processing, determination of the AI model or the like is performed according to the information of the device targeted for the deployment processing of the AI model or the AI utilization software, for example, the information of the camera 3 or the fog server 4, the performance required by the customer, or the like.

Furthermore, in the deployment preparation processing, the AI utilization software for implementing the function desired by the customer is also determined on the basis of the performance information of each device and the request information of the customer.

In subsequent step S7, the server apparatus 100 performs processing of deploying the AI utilization software and the AI model prepared by the above-described deployment preparation processing to the camera 3.

In response to this, in step S51, the camera 3 performs installation processing of the AI utilization software and the AI model. Thus, AI processing can be performed on the captured image captured by the camera 3.

Note that, although not illustrated in FIG. 4, similarly, in the fog server 4, the deployment processing of the AI utilization software and the AI model is performed as necessary.

However, in a case where all the processes are executed in the camera 3, the deployment processing for the fog server 4 is not performed.

In step S52, the camera 3 acquires an image by performing an imaging operation. Then, in step S53, the camera 3 performs AI processing on the acquired image, and obtains, for example, an image recognition result.

In step S54, the camera 3 performs transmission processing of the captured image and the result information of the AI processing. In the information transmission in step S54, both the captured image and the result information of the AI image processing may be transmitted, or only one of the captured image and the result information of the AI image processing may be transmitted.

The server apparatus 100 that has received these pieces of information performs analysis processing in step S8. By this analysis processing, for example, flow line analysis of an in-store customer, vehicle analysis processing for traffic monitoring, and the like are performed.

Then, in subsequent step S9, the server apparatus 100 performs presentation processing of an analysis result. This processing is implemented, for example, by a customer using a cloud application as described later. By performing this analysis processing, the customer terminal 2 displays the analysis result in step S42.

By the processing as described above, the customer who is the user of the AI utilization software can obtain the analysis result corresponding to the purpose selected in step S41 described above.

Note that the server apparatus 100 may update the AI model after step S9. By updating and deploying the AI model, it is possible to obtain an analysis result suitable for the use environment of the user.

Here, a cloud application is deployed in the server apparatus 100 as a cloud side, and a system user such as a customer can use the cloud application via the network 5. In the cloud application, an application or the like for performing the analysis processing described above is prepared. For example, it is an application or the like that analyzes a flow line of an in-store customer using attribute information or image information (for example, a person extraction image or the like) of the in-store customer.

For example, by using a cloud application for flow line analysis using the customer terminal 2, a system user as a customer can perform flow line analysis of an in-store customer of the system user's own store and browse an analysis result. The presentation of the analysis result is performed, for example, by graphically presenting a flow line of an in-store customer on a map of the store.

The result of the flow line analysis may be displayed in the form of, for example, a heat map, and the density of in-store customers or the like may be presented. In addition, the flow line information may be sorted for each attribute information of an in-store customer.

Note that the analysis processing includes, for example, processing of analyzing a traffic volume in addition to the above-described processing of analyzing flow lines. For example, in the case of processing of analyzing flow lines, processing result information obtained by performing image recognition processing of recognizing a person is obtained for each captured image captured by the camera 3. Then, the capturing time of each captured image and a pixel area where a person to be detected is detected are specified on the basis of the processing result information, and the movement of the person in the store is finally grasped to analyze the flow line of the target person.

In a case where not only the movement of a specific person but also the movement of a store visitor is grasped as a whole, by performing such processing for each store visitor and finally performing statistical processing, a general flow line or the like of the store visitor can be analyzed.

Here, in the cloud-side marketplace, an AI model optimized for each customer may be registered. Specifically, for example, a captured image captured by the camera 3 arranged in a store managed by a certain customer is appropriately uploaded and accumulated on the cloud side, and the server apparatus 100 performs relearning processing of the AI model every time a certain number of the uploaded captured images are accumulated, and re-registers the AI model after the relearning in the marketplace.

Furthermore, in a case where personal information is included in information (for example, image information) uploaded from the camera 3 to the server apparatus 100, data from which information regarding privacy is excluded from the viewpoint of privacy protection may be uploaded, or the data from which information regarding privacy is excluded may be used by the AI model developer or the software developer.

### (1-4. Configuration of Information Processing Apparatus)

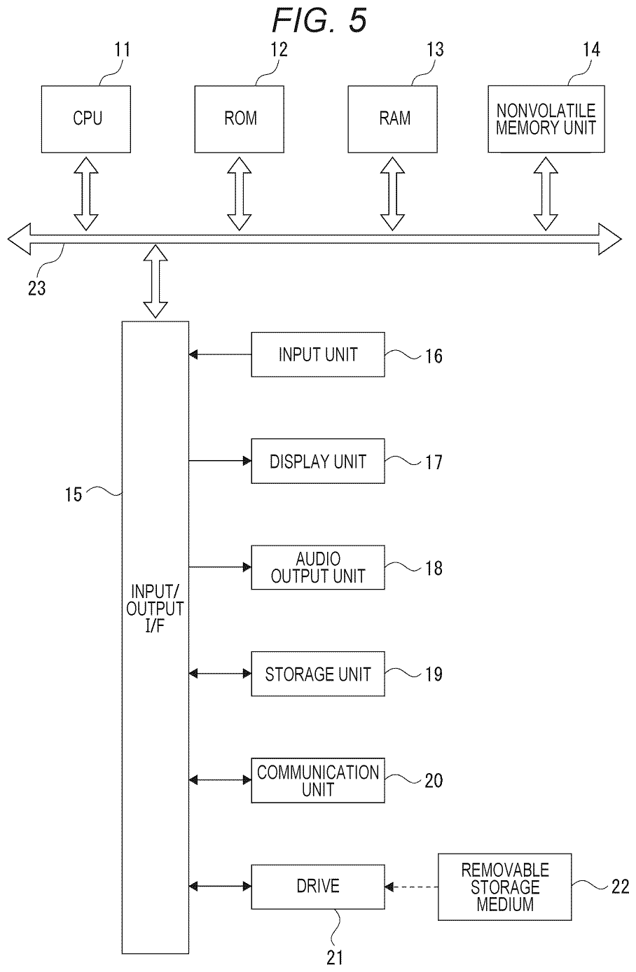

FIG. 5 is a block diagram illustrating a hardware configuration example of each computer apparatus as various information processing apparatuses constituting the information processing system SY illustrated in FIG. 1, specifically, the server apparatus 100, the customer terminal 2, the AI model developer terminal 6, and the software developer terminal 7.

As illustrated, the computer apparatus includes a CPU 11. The CPU 11 functions as an arithmetic processing unit that performs various types of processing for implementing the functions as the server apparatus 100, the customer terminal 2, the AI model developer terminal 6, the software developer terminal 7, and the like described above, and executes various types of processing according to a program stored in a nonvolatile memory unit 14 such as a ROM 12 or an electrically erasable programmable read-only memory (EEP-ROM), or a program loaded from a storage unit 19 to a RAM 13. The RAM 13 also appropriately stores data and the like necessary for the CPU 11 to execute various types of processing.

The CPU 11, the ROM 12, the RAM 13, and the nonvolatile memory unit 14 are connected to one another via a bus 23. Furthermore, an input/output interface (I/F) 15 is also connected to the bus 23.

An input unit 16 including an operation element or an operation device is connected to the input/output interface 15. For example, as the input unit 16, various types of operation elements and operation devices such as a keyboard, a mouse, a key, a dial, a touch panel, a touch pad, and a remote controller are assumed.

Operation by a user is sensed by the input unit 16, and a signal corresponding to the input operation is interpreted by the CPU 11.

Furthermore, a display unit 17 including a liquid crystal display (LCD), an organic electro-luminescence (EL) panel, or the like, and an audio output unit 18 including a speaker or the like are integrally or separately connected to the input/output interface 15.

The display unit 17 is used for displaying various types of information, and includes, for example, a display device provided in a housing of a computer apparatus, a separate display device connected to the computer apparatus, or the like.

The display unit 17 executes display of an image for various types of image processing, a moving image to be processed, or the like on a display screen on the basis of an instruction from the CPU 11. Furthermore, the display unit 17 displays various operation menus, icons, messages, and the like, that is, performs display as a graphical user interface (GUI), on the basis of an instruction from the CPU 11.

In some cases, the storage unit 19 including a hard disk drive (HDD), a solid-state memory, or the like, and a communication unit 20 including a modem or the like are connected to the input/output interface 15.

The communication unit 20 performs communication processing via a transmission path such as the Internet, and performs wired/wireless communication with various devices and communication based on bus communication or the like.

A drive 21 is also connected to the input/output interface 15 as needed, and a removable storage medium 22 such as a magnetic disk, an optical disc, a magneto-optical disk, or a semiconductor memory is mounted.

A data file such as a program used for each processing can be read from the removable storage medium 22 by the drive 21. The read data file is stored in the storage unit 19, and an image or audio included in the data file is output by the display unit 17 or the audio output unit 18. Furthermore, a computer program and the like read from the removable storage medium 22 is installed in the storage unit 19 as needed.

In the computer apparatus having the hardware configuration as described above, software for implementing various types of processing can be installed via network communication by the communication unit 20 or the removable storage medium 22. Alternatively, the software may be stored in advance in the ROM 12, the storage unit 19, or the like.

When the CPU 11 performs processing operation on the basis of various programs, information processing and communication processing necessary as the server apparatus 100, the customer terminal 2, the AI model developer terminal 6, and the software developer terminal 7 described above are executed.

Note that, among the server apparatus 100, the customer terminal 2, the AI model developer terminal 6, and the software developer terminal 7, in particular, the server apparatus 100 is not limited to a single computer apparatus as illustrated in FIG. 5, and a plurality of computer apparatuses may be systemized. The plurality of computer apparatuses may be systematized by a local area network (LAN) or the like, or may be arranged in a remote place by a virtual private network (VPN) or the like using the Internet or the like. The plurality of computer apparatuses may include a computer apparatus as a server group (cloud) that can be used by a cloud computing service.

### (1-5. Configuration of Imaging Device)

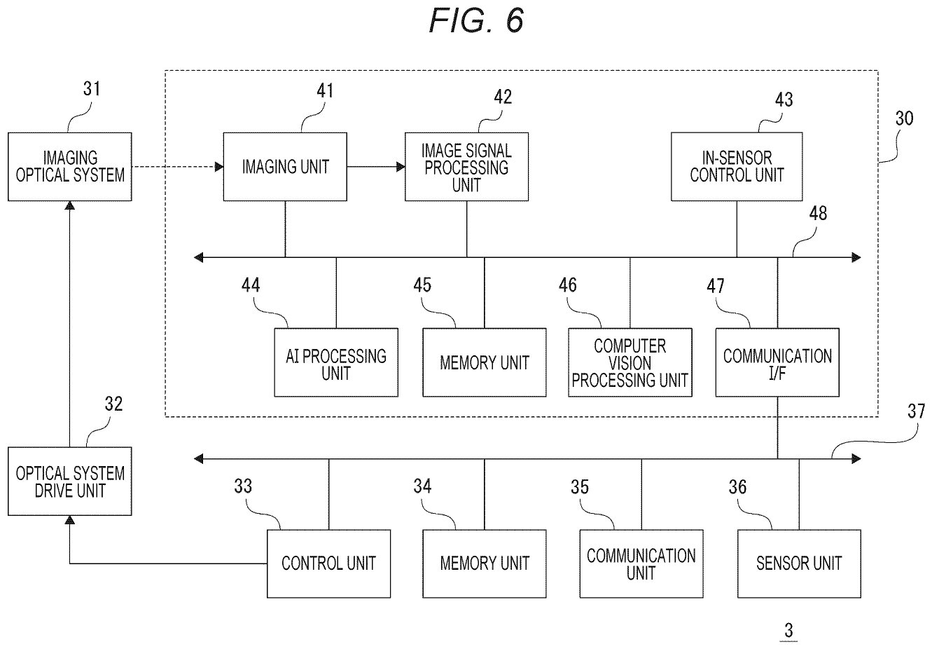

FIG. 6 is a block diagram illustrating a configuration example of the camera 3.

As illustrated, the camera 3 includes an image sensor 30, an imaging optical system 31, an optical system drive unit 32, a control unit 33, a memory unit 34, a communication unit 35, and a sensor unit 36. The image sensor 30, the control unit 33, the memory unit 34, the communication unit 35, and the sensor unit 36 are connected via a bus 37, and can perform data communication with each other.

The imaging optical system 31 includes various optical components for imaging, such as lenses such as a cover lens, a zoom lens, and a focus lens, and a diaphragm (iris) mechanism. Light (incident light) from a subject is guided by the imaging optical system 31 and condensed on a light receiving surface of the image sensor 30.

The optical system drive unit 32 comprehensively represents drive units of the zoom lens, the focus lens, and the diaphragm mechanism included in the imaging optical system 31. Specifically, the optical system drive unit 32 includes an actuator for driving each of the zoom lens, the focus lens, and the diaphragm mechanism, and a drive circuit of the actuator.

The control unit 33 includes, for example, a microcomputer including a CPU, a ROM, and a RAM, and performs the overall control of the camera 3 by causing the CPU to perform various types of processing in accordance with a program stored in the ROM or a program loaded in the RAM.

Furthermore, the control unit 33 instructs the optical system drive unit 32 to drive the zoom lens, the focus lens, the diaphragm mechanism, and the like. The optical system drive unit 32 moves the focus lens and the zoom lens, opens or closes a diaphragm blade of the diaphragm mechanism, or the like in response to such a drive instruction.

Furthermore, the control unit 33 controls the writing and reading of various types of data to and from the memory unit 34.

The memory unit 34 is a nonvolatile storage device such as an HDD or a flash memory device, for example, and is used for storing data used when the control unit 33 executes various types of processing. Furthermore, the memory unit 34 can also be used as a storage destination (recording destination) of the image data output from the image sensor 30.

Furthermore, the control unit 33 performs various kinds of data communication with an external apparatus via the communication unit 35. The communication unit 35 in the present example is able to perform data communication with at least the fog server 4 illustrated in FIG. 1.

Alternatively, the communication unit 35 is capable of communicating over the network 5, and communicates data with the server apparatus 100 in some cases.

The sensor unit 36 comprehensively represents sensors other than the image sensor 30 included in the camera 3. Examples of the sensors included in the sensor unit 36 include a global navigation satellite system (GNSS) sensor for detecting the position and altitude of the camera 3, an altitude sensor, a temperature sensor for detecting ambient temperature, and a motion sensor such as an acceleration sensor or an angular velocity sensor for detecting the motion of the camera 3.

The image sensor 30 is configured as a solid-state imaging element of a CCD type, a CMOS type, or the like, for example, and includes an imaging unit 41, an image signal processing unit 42, an in-sensor control unit 43, an AI processing unit 44, a memory unit 45, a computer vision processing unit 46, and a communication interface (I/F) 47 as illustrated in the drawing, all of which are capable of data communication with each other via a bus 48 as illustrated.

The imaging unit 41 includes a pixel array unit in which pixels each having a photoelectric conversion element such as a photodiode are two-dimensionally arranged, and a reading circuit that reads an electric signal obtained by photoelectric conversion from each pixel included in the pixel array unit.

This readout circuit performs, for example, correlated double sampling (CDS) processing, automatic gain control (AGC) processing, and the like on the electric signal obtained by the photoelectric conversion, and further performs analog/digital (A/D) conversion processing on the electric signal.

The image signal processing unit 42 performs preprocessing, synchronization processing, YC generation processing, resolution conversion processing, codec processing, and the like on a captured image signal as digital data obtained as a result of the A/D conversion processing.

In the preprocessing, clamp processing of clamping the black level of red (R), green (G), and blue (B) to a predetermined level, correction processing among R, G, and B color channels and the like are performed on the captured image signal. In the synchronization processing, color separation processing is performed so that image data for each pixel has all the R, G, and B color components. For example, in a case of an imaging element using a color filter of Bayer array, demosaicing processing is performed as the color separation processing. In the YC generation processing, a luminance (Y) signal and a color (C) signal are generated (separated) from the image data of R, G, and B. In the resolution conversion processing, resolution conversion processing is executed on the image data subjected to various types of signal processing.

In the codec processing, for example, encoding processing for recording or communication and file generation are performed on the image data subjected to the various types of processing described above. In the codec processing, it is possible to generate a file in a format such as moving picture experts group (MPEG)-2 or H.264 as a moving image file format. It is also conceivable to generate a file in a format such as joint photographic experts group (JPEG), tagged image file format (TIFF), or graphics interchange format (GIF) as a still image file.

The in-sensor control unit 43 includes a microcomputer including, for example, a CPU, a ROM, a RAM, and the like, and integrally controls the operation of the image sensor 30. For example, the in-sensor control unit 43 performs execution control of the imaging operation by issuing an instruction to the imaging unit 41. Similarly, execution of processing is also controlled for the image signal processing unit 42.

The AI processing unit 44 includes a programmable arithmetic processing device such as a CPU, a field programmable gate array (FPGA), or a digital signal processor (DSP), for example, and performs image processing using an AI model on a captured image.

Examples of the image processing (AI processing) by the AI processing unit 44 include object recognition processing of recognizing a subject as a specific target such as a person or a vehicle. Furthermore, it is also conceivable that the AI processing is performed as object detection processing of detecting an area where an object exists.

The function of the AI processing by the AI processing unit 44 can be switched by changing the AI model (algorithm of the AI processing). Hereinafter, an example in a case where the AI processing is processing related to image recognition will be described.

Although various specific examples of the processing related to the recognition of the image are conceivable, for example, types as exemplified below can be exemplified.
Class identification
Semantic segmentation
Human detection
Vehicle detection
Target tracking
Optical character recognition (OCR)

Among the above function types, the class identification is a function of identifying a class of a target. The term “class” described herein refers to information representing a category of an object, and refers to, for example, classifications such as “person”, “automobile”, “airplane”, “ship”, “truck”, “bird”, “cat”, “dog”, “deer”, “frog”, “horse”, and the like.

The target tracking is a function of tracking a target subject, and can be also described as a function of obtaining history information of a position of the subject.

The memory unit 45 includes a volatile memory, and is used to hold (temporarily store) data necessary for the AI processing by the AI processing unit 44. Specifically, it is used for holding an AI model, AI utilization software, and firmware required for performing AI processing by the AI processing unit 44. Furthermore, it is also used to hold data used in processing performed by the AI processing unit 44 using the AI model.

In the present example, the memory unit 45 is also used to hold captured image data processed by the image signal processing unit 42.

Hereinafter, data necessary for the AI processing unit 44 to perform the AI processing is referred to as “AI model data”. For example, in a case where the AI processing is implemented by the CNN including a convolution operation, the AI model data includes various processing parameters such as a weight coefficient used for the convolution operation, setting information (for example, information of the kernel size is included) related to the neural network structure, and the like.

The computer vision processing unit 46 performs rule-based image processing as image processing on the captured image data. Examples of the rule-based image processing given here include super-resolution processing and the like.

The communication interface 47 is an interface that communicates with each unit connected via the bus 37, such as the control unit 33 and the memory unit 34 outside the image sensor 30. For example, the communication interface 47 performs communication for acquiring AI-utilizing software, AI model data, and the like used by the AI processing unit 44 from the outside on the basis of the control of the in-sensor control unit 43.

Furthermore, result information of AI processing by the AI processing unit 44 is output to the outside of the image sensor 30 via the communication interface 47.

### (1-6. Sensor Structure)

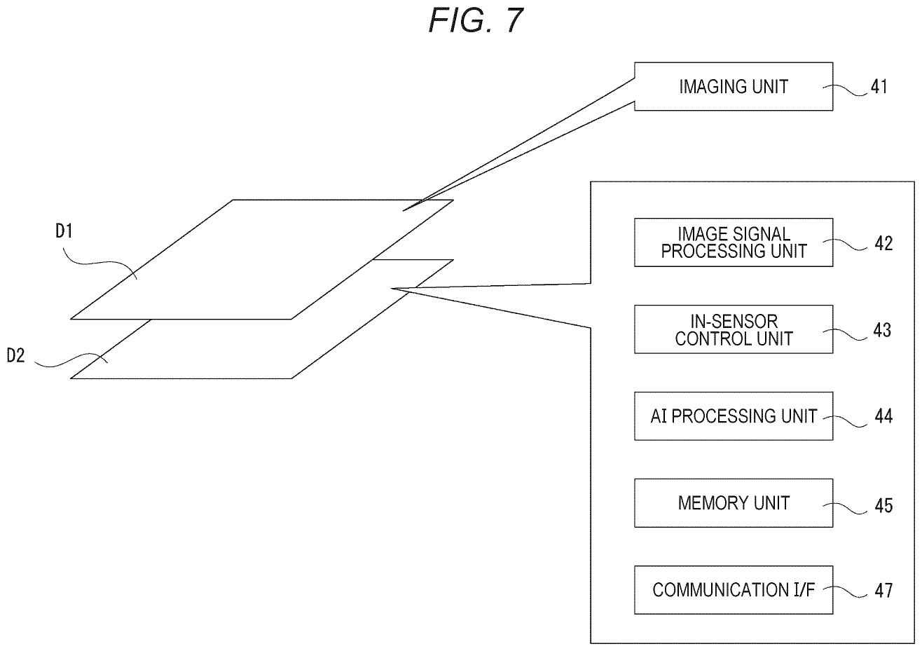

Various structures of the image sensor 30 can be considered. As an example, the image sensor 30 in the present example has a two-layer structure as illustrated in FIG. 7.

In FIG. 7, the image sensor 30 in this case is configured as a one-chip semiconductor device in which two dies D1 and D2 are stacked. The die D1 is a die in which the imaging unit 41 (see FIG. 6) is formed, and the die D2 is a die including the image signal processing unit 42, the in-sensor control unit 43, the AI processing unit 44, the memory unit 45, the computer vision processing unit 46, and the communication I/F 47.

The die D1 and the die D2 are electrically connected by, for example, an inter-chip bonding technique such as Cu-Cu bonding.

### (1-7. Connection Between Cloud and Edge)

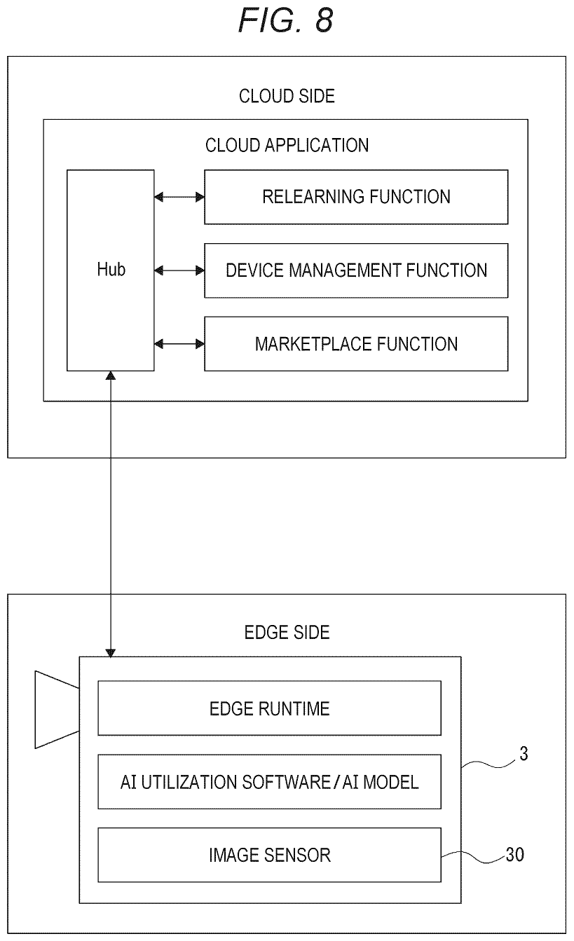

For example, connection between the server apparatus 100 that is an information processing apparatus on the cloud side and the camera 3 that is an information processing apparatus on the edge side may be in a mode as illustrated in FIG. 8.

In the information processing apparatus on the cloud side, a relearning function, a device management function, and a marketplace function, which are functions available via a hub, are implemented. The hub performs highly reliable communication protected by security with respect to the edge-side information processing apparatus. Thus, various functions can be securely provided to the edge-side information processing apparatus.

The relearning function is a function of providing a newly optimized AI model by performing relearning as described above, and accordingly, an appropriate AI model based on a new learning material is provided.

The device management function is a function of managing the camera 3 and the like as the edge-side information processing apparatus, and can provide, for example, functions such as management and monitoring of the AI model deployed in the camera 3, and problem detection and troubleshooting.

Moreover, the device management function protects secure access by authenticated users.

As described above, the marketplace function provides a function of registering the AI model developed by the AI model developer and the AI utilization software developed by the software developer, a function of deploying these developed products to the permitted edge-side information processing apparatus, and the like. Furthermore, the marketplace function is also provided with a function related to payment of an incentive according to deployment of the developed products.

The camera 3 as the edge-side information processing apparatus includes edge runtime, AI utilization software, an AI model, and an image sensor 30.

The edge runtime functions as, for example, embedded software for managing software deployed in the camera 3 and communicating with the cloud-side information processing apparatus.

As described above, the AI model is a model in which the AI model (or the AI model after relearning) registered in the marketplace in the cloud-side information processing apparatus is deployed, whereby the camera 3 can obtain the result information of the AI processing according to the purpose using the captured image.

### (1-8. Deployment Using Container Technology)

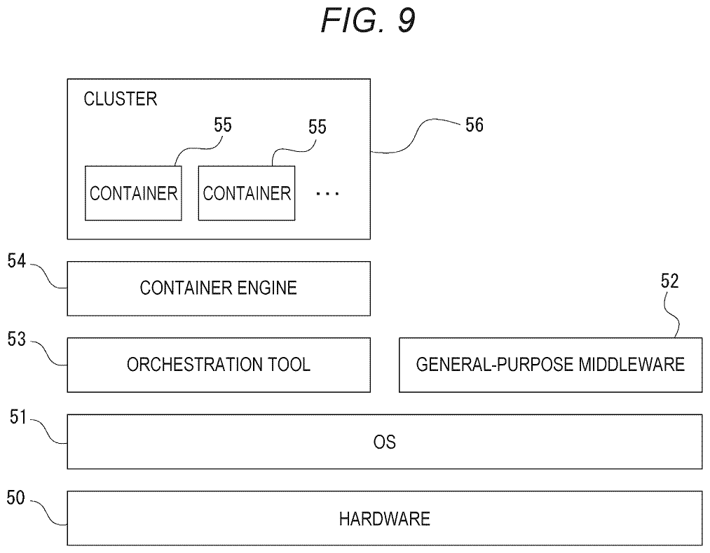

Furthermore, various methods of deploying the AI model and the AI utilization software to the camera 3 can be considered. As an example, an example using the container technology will be described with reference to FIG. 9.

As illustrated in FIG. 9, in the camera 3, an operation system 51 is installed on various types of hardware 50 such as a CPU, a graphics processing unit (GPU), a ROM, and a RAM as the control unit 33 illustrated in FIG. 6 described above.

The operation system 51 is basic software that performs overall control of the camera 3 in order to implement various functions in the camera 3.

General-purpose middleware 52 is installed on the operation system 51. The general-purpose middleware 52 is, for example, software for implementing basic operations such as a communication function using the communication unit 35 as the hardware 50 and a display function using a display unit (such as a monitor) as the hardware 50.

On the operation system 51, not only the general-purpose middleware 52 but also an orchestration tool 53 and a container engine 54 are installed.

The orchestration tool 53 and the container engine 54 deploy and execute a container 55 by constructing a cluster 56 as an operation environment of the container 55.

Note that the edge runtime illustrated in FIG. 8 corresponds to the orchestration tool 53 and the container engine 54 illustrated in FIG. 9.

The orchestration tool 53 has a function for causing the container engine 54 to appropriately allocate the resources of the hardware 50 and the operation system 51 described above. Each container 55 is put together in a predetermined unit (pod as described later) by the orchestration tool 53, and each pod is expanded to a worker node (as described later) which is a logically different area.

The container engine 54 is one of middleware installed in the operation system 51, and is an engine that operates the container 55. Specifically, the container engine 54 has a function of allocating resources (memory, operation capability, and the like) of the hardware 50 and the operation system 51 to the container 55 on the basis of a configuration file or the like included in the middleware in the container 55.

Furthermore, the resources allocated in the present embodiment include not only resources of the control unit 33 and the like included in the camera 3 but also resources of the in-sensor control unit 43, the memory unit 45, the communication I/F 47, and the like included in the image sensor 30.

The container 55 includes an application for implementing a predetermined function and middleware such as a library.

The container 55 operates to implement predetermined functions using the resources of the hardware 50 and the operation system 51 allocated by the container engine 54.

In the present embodiment, the AI utilization software and the AI model illustrated in FIG. 8 correspond to one of the containers 55. That is, one of the various containers 55 deployed in the camera 3 implements a predetermined AI processing function using the AI utilization software and the AI model.

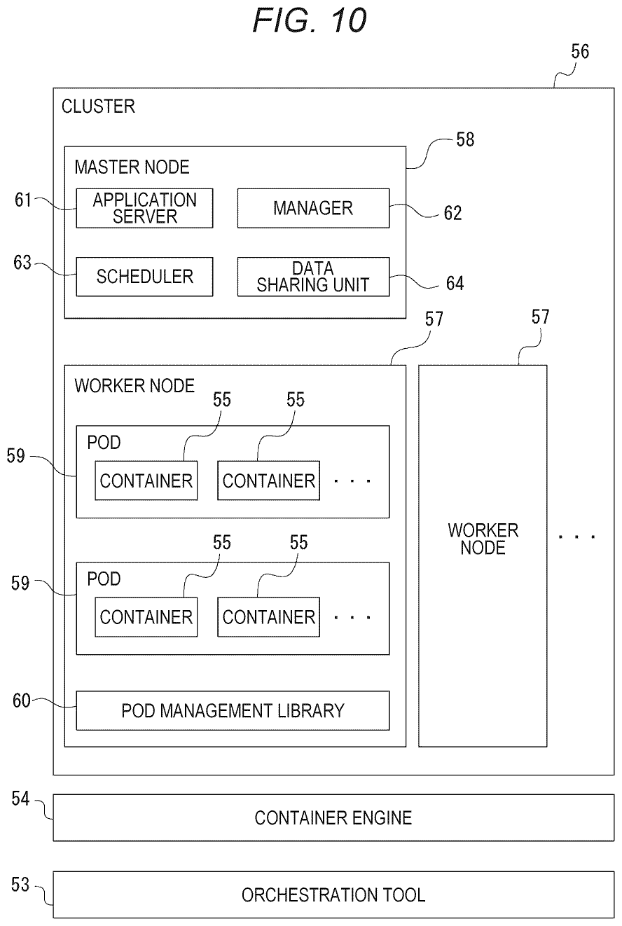

A specific configuration example of the cluster 56 constructed by the container engine 54 and the orchestration tool 53 will be described with reference to FIG. 10.

Note that the cluster 56 may be constructed across a plurality of devices so that functions are implemented using not only the hardware 50 included in one camera 3 but also resources of other hardware included in other devices.

The orchestration tool 53 manages the execution environment of the container 55 in units of worker nodes 57. Furthermore, the orchestration tool 53 constructs a master node 58 that manages the entire worker node 57.

In the worker node 57, a plurality of pods 59 is deployed. The pod 59 is configured to include one or a plurality of containers 55, and implements a predetermined function. The pod 59 is a management unit for managing the container 55 by the orchestration tool 53.

The operation of the pod 59 in the worker node 57 is controlled by a pod management library 60.

The pod management library 60 includes a container runtime for causing the pod 59 to use a logically allocated resource of the hardware 50, an agent that receives control from the master node 58, a network proxy that performs communication between the pods 59 and communication with the master node 58, and the like.

That is, each pod 59 can implement a predetermined function using each resource by the pod management library 60.

The master node 58 includes an application server 61 that develops the pod 59, a manager 62 that manages a state of development of the container 55 by the application server 61, a scheduler 63 that determines a worker node 57 in which the container 55 is arranged, and a data sharing unit 64 that performs data sharing.

By using the configurations illustrated in FIGS. 9 and 10, it is possible to cause the image sensor 30 of the camera 3 to execute the above-described AI utilization software and processing as an AI model using the container technology.

Note that, as described above, the AI model may be stored in the memory unit 45 in the image sensor 30 via the communication I/F 47 in FIG. 6, and the AI processing may be executed in the image sensor 30, or the configurations illustrated in FIGS. 9 and 10 may be developed in the memory unit 45 and the in-sensor control unit 43 in the image sensor 30, and the above-described AI utilization software and AI model may be executed in the image sensor 30 using the container technology.

### (1-9. Flow of Processing Related to AI Model Relearning)

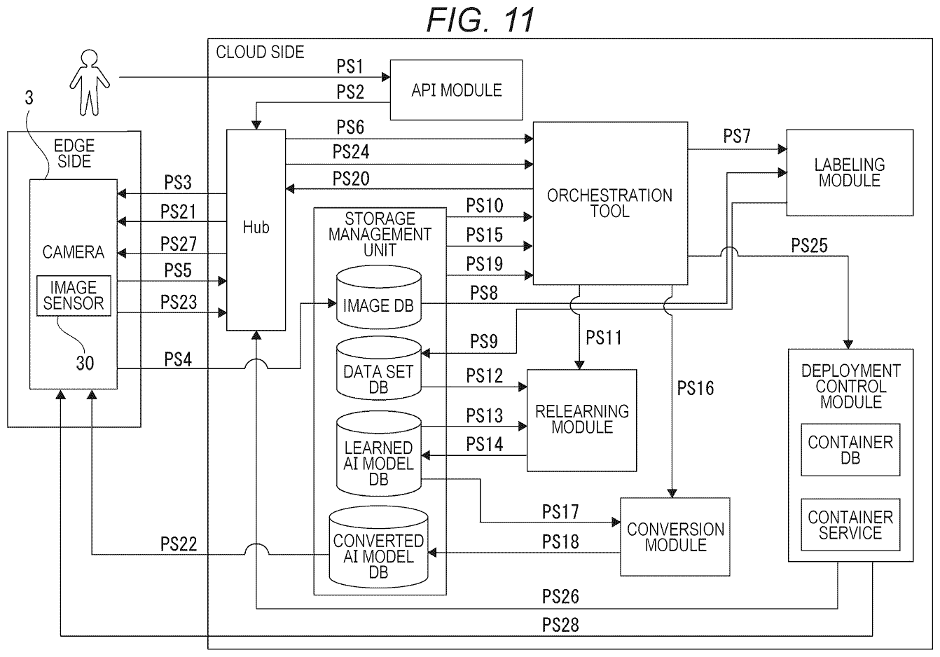

An example of a flow of processing when relearning of the AI model, an AI model (edge-side AI model) deployed in each camera 3, and update of the AI utilization software are performed will be described with reference to FIG. 11.

Here, as an example, a case where relearning of the AI model and update of the edge-side AI model and the AI utilization software are performed with an operation of a service provider or a user as a trigger will be described.

Note that FIG. 11 focuses on one camera 3 among the plurality of cameras 3. Furthermore, the edge-side AI model to be updated in the following description is deployed in the image sensor 30 included in the camera 3. However, the edge-side AI model may be deployed in a memory provided in a portion outside the image sensor 30 in the camera 3.

First, in processing step PS1, a service provider or a user (customer) instructs to perform relearning of the AI model. This instruction is performed using an application programming interface (API) function by an API module included in the cloud-side information processing apparatus. Furthermore, in the instruction, an image amount (for example, the number of images) used for learning is designated. Hereinafter, the number of images designated as the image amount used for learning is also referred to as “predetermined number of images”.

In response to the instruction, the API module transmits a relearning request and information of the image amount to a hub (similar to that illustrated in FIG. 8) in processing step PS2.

In processing step PS3, the hub transmits the update notification and the information of the image amount to the camera 3 as the edge-side information processing apparatus.

The camera 3 transmits captured image data obtained by performing imaging to an image database (DB) of the storage group in processing step PS4. The photographing processing and the transmission processing are performed until the predetermined number of images necessary for relearning is achieved.

Note that, in a case where the camera 3 obtains an inference result by performing the inference processing on the captured image data, the camera 3 may store the inference result in the image DB as metadata of the captured image data in processing step PS4.

Since the inference result in the camera 3 is stored in the image DB as metadata, it is possible to carefully select data necessary for relearning of the AI model executed on the cloud side. Specifically, the relearning can be performed using only the image data in which the inference result in the camera 3 is different from a result of inference performed using abundant computer resources in the cloud-side information processing apparatus. Therefore, the time required for relearning can be shortened.

After finishing the capturing and transmission of the predetermined number of images, the camera 3 notifies the hub that the transmission of the captured image data of the predetermined number of images has been completed in processing step PS5.

Upon receiving the notification, the hub notifies the orchestration tool that the preparation of the data for relearning is completed in processing step PS6.

In processing step PS7, the orchestration tool transmits an execution instruction of labeling processing to the labeling module.

The labeling module acquires image data to be subjected to the labeling processing from the image DB (processing step PS8), and performs the labeling processing.

The labeling processing described herein may be processing of performing the class identification described above, processing of estimating the gender and the age of a subject of the image and giving a label, processing of estimating the pose of the subject and giving a label, or processing of estimating the behavior of the subject and giving a label.

The labeling processing may be performed manually or automatically. In addition, the labeling processing may be completed by a cloud-side information processing apparatus, or may be implemented by using a service provided by another server apparatus.

The labeling module that has completed the labeling processing stores result information of labeling in a data set DB in processing step PS9. Here, the information stored in the data set DB may be a set of label information and image data, or may be image identification (ID) information for specifying image data instead of the image data itself.

A storage management unit that has detected that the result information of labeling has been stored notifies the orchestration tool in processing step PS10.

The orchestration tool that has received the notification confirms that the labeling processing for the image data of the predetermined number of images has ended, and transmits a relearning instruction to a relearning module in processing step PS11.

The relearning module that has received the relearning instruction acquires the data set used for learning from the data set DB in processing step PS12, and acquires the AI model to be updated from a learned AI model DB in processing step PS13.

The relearning module relearns the AI model by using the acquired data set and the AI model. The updated AI model obtained in this manner is stored again in the learned AI model DB in processing step PS14.

The storage management unit that has detected that the updated AI model is stored notifies the orchestration tool in processing step PS15.

The orchestration tool that has received the notification transmits a conversion instruction of the AI model to a conversion module in processing step S16.

The conversion module that has received the conversion instruction acquires the updated AI model from the learned AI model DB in processing step PS17, and performs conversion processing of the AI model.

In the conversion processing, processing of performing conversion according to specification information or the like of the camera 3, which is the deployment destination device, is performed. In this processing, downsizing is performed so as not to degrade the performance of the AI model as much as possible, and file format conversion or the like is performed so as to be operable on the camera 3.

The AI model converted by the conversion module is the above-described edge-side AI model. The converted AI model is stored in the converted AI model DB in processing step PS18.

The storage management unit that has detected that the converted AI model is stored notifies the orchestration tool in processing step PS19.

In processing step PS20, the orchestration tool that has received the notification transmits a notification for executing the update of the AI model to the hub. This notification includes information for specifying a place where the AI model used for update is stored.

Upon receiving the notification, the hub transmits an instruction to update the AI model to the camera 3. The instruction to update also includes information for specifying a place where the AI model is stored.

In processing step PS22, the camera 3 performs processing of acquiring and installing the target converted AI model from the converted AI model DB. Thus, the AI model used by the image sensor 30 of the camera 3 is updated.

The camera 3 that has completed the update of the AI model by installing the AI model transmits an update completion notification to the hub in processing step PS23.

Upon receiving the notification, the hub notifies the orchestration tool that AI model update processing of the camera 3 has been completed in processing step PS24.

Note that, in a case where only the update of the AI model is performed, the processing so far is completed.

In a case where the AI utilization software or firmware is updated in addition to the AI model, the following processing is further executed.

Specifically, in processing step PS25, the orchestration tool transmits an instruction to download the updated AI utilization software or firmware to a deployment control module.

In processing step PS26, the deployment control module transmits an AI utilization software or firmware deployment instruction to the hub. This instruction includes information for specifying a place where the updated AI utilization software and firmware are stored.

In processing step PS27, the hub transmits the deployment instruction to the camera 3.

In processing step PS28, the camera 3 downloads and installs the updated AI utilization software and firmware from the container DB of the deployment control module.

Note that, in the above description, an example has been described in which the update of the AI model operating on the image sensor 30 of the camera 3 and the update of the AI utilization software operating outside the image sensor 30 in the camera 3 are sequentially performed.

In a case where both the AI model and the AI utilization software operate outside the image sensor 30 of the camera 3, both the AI model and the AI utilization software may be collectively updated as one container. In that case, the update of the AI model and the update of the AI utilization software may be performed simultaneously instead of sequentially. Then, it can be implemented by executing each processing of processing steps PS25, PS26, PS27, and PS28.

Note that, even in a case where the container can be deployed in the image sensor 30 of the camera 3, the AI model and the AI utilization software can be updated by executing each processing of processing steps PS25, PS26, PS27, and PS28.

By performing the above-described processing, the relearning of the AI model is performed using the captured image data captured in the use environment of the user. Therefore, it is possible to generate the edge-side AI model capable of outputting a highly accurate recognition result in the use environment of the user.

Furthermore, even if the use environment of the user changes, for example, in a case where the layout in the store is changed or a case where the installation place of the camera 3 is changed, the AI model can be appropriately relearned each time, and thus it is possible to maintain recognition accuracy by the AI model without deteriorating.

Note that each processing described above may be executed not only when the AI model is relearned but also when the system is operated for the first time under the use environment of the user.

### (1-10. Screen Example of Marketplace)

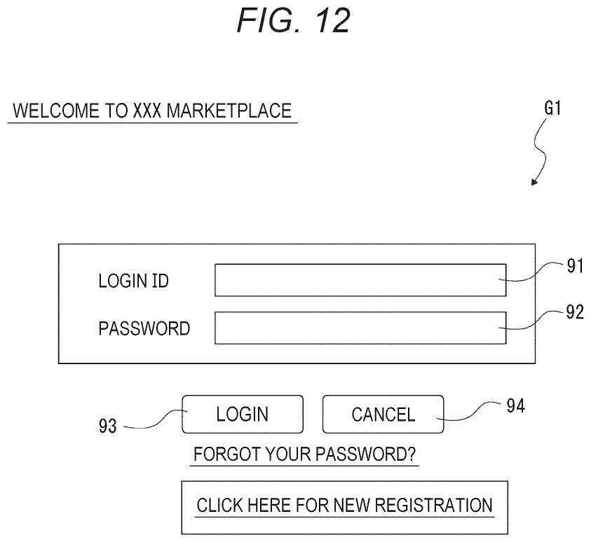

A screen example of the marketplace presented to the user will be described with reference to FIGS. 12 to 14.

FIG. 12 Illustrates an Example of the Login Screen G1.

The login screen G1 is provided with an ID input field 91 for the system user to input a user ID and a password input field 92 for the system user to input a password.

Below the password input field 92, a login button 93 for performing login and a cancel button 94 for canceling login are arranged.

Furthermore, an operation element for transitioning to a page for a user who forgets a password, an operation element for transitioning to a page for newly performing user registration, and the like are appropriately arranged below the page.

When the login button 93 is pressed after an appropriate user ID and password are input, processing of transitioning to a user-specific page is executed in each of the server apparatus 100 and the customer terminal 2.

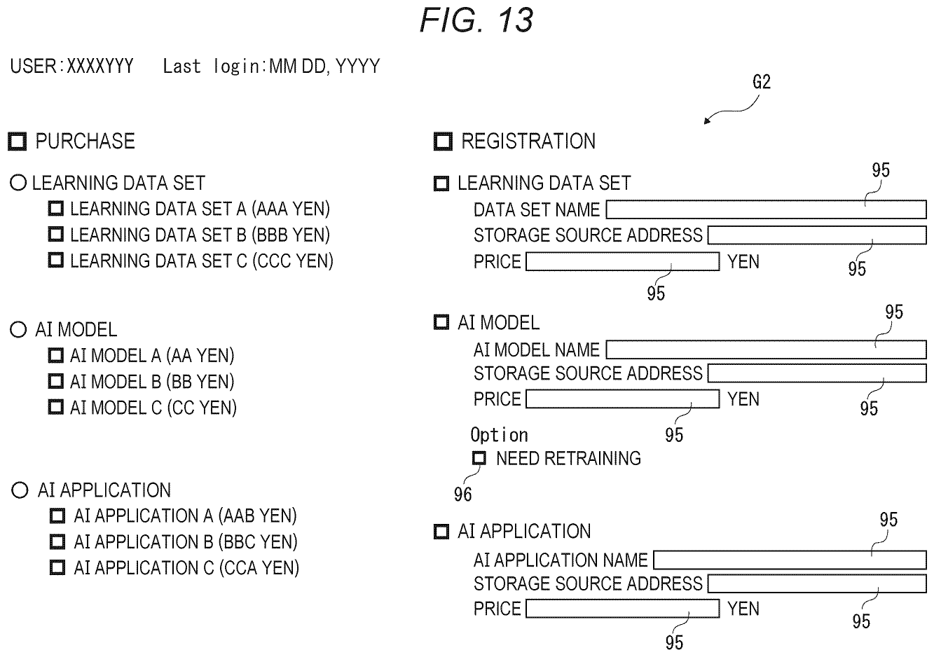

FIG. 13 illustrates an example of a developer screen G2 presented to a software developer who uses the software developer terminal 7 and an AI model developer who uses the AI model developer terminal 6.

Each developer can purchase a learning data set, an AI model, and AI utilization software (denoted as “AI application” in the drawing) through a marketplace for development. Furthermore, it is possible to register the AI utilization software and the AI model developed by oneself in the marketplace.

On the developer screen G2 illustrated in FIG. 13, purchasable learning data sets, AI models, AI utilization software (AI application), and the like (hereinafter, collectively referred to as “data”) are displayed on the left side.

Note that, although not illustrated, at the time of purchasing the learning data set, it is also possible to prepare for learning by displaying an image of the learning data set on a display, surrounding only a desired portion of the image with a frame using an input device such as a mouse, and inputting a name.

For example, in a case where it is desired to perform AI learning with an image of a cat, by surrounding only a portion of the cat on the image with a frame and inputting “cat” as text input, an image to which a cat annotation has been added can be prepared for AI learning.

Furthermore, a purpose may be selectable so that desired data can be easily found. That is, display processing in which only data suitable for the selected purpose is displayed is executed in each of the server apparatus 100 and the customer terminal 2.

Note that the purchase price of each data may be displayed on the developer screen G2.

Furthermore, on the right side of the developer screen G2, input fields 95 for registering a learning data set collected or created by the developer, an AI model developed by the developer, and AI utilization software are provided.

Input fields 95 for inputting a name and a data storage location are provided for each data. Furthermore, a check box 96 for setting necessity/unnecessity of retraining is provided for the AI model.

Note that a price setting field or the like in which a sales price of data to be registered can be set may be provided as the input field 95.

Furthermore, in the upper part of the developer screen G2, a user name, a final login date, and the like are displayed as part of the user information. Note that, in addition to this, the amount of currency, the number of points, and the like that can be used when the user purchases data may be displayed.

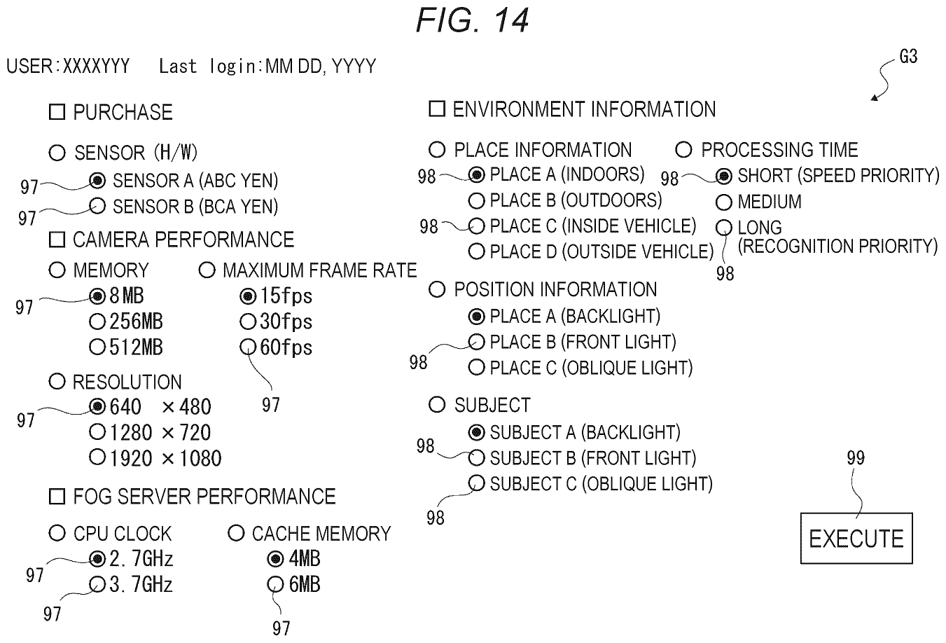

FIG. 14 is an example of a user screen G3. The user screen G3 is a screen presented to a user as a service user, that is, a user who receives presentation of various analysis results (the above-described application user) by deploying the AI utilization software or the AI model in the camera 3 managed by the user.

The user can purchase the camera 3 to be arranged in the space to be monitored via the marketplace. Therefore, on the left side of the user screen G3, radio buttons 97 capable of selecting the type of the image sensor 30 mounted on the camera 3, the performance of the camera 3, and the like are arranged.

Furthermore, the user can purchase the information processing apparatus as the fog server 4 via the marketplace. Therefore, radio buttons 97 for selecting respective performances of the fog server 4 are arranged on the left side of the user screen G3.

Furthermore, the user who already has the fog server 4 can register the performance of the fog server 4 by inputting the performance information of the fog server 4 here.

The user implements a desired function by installing the purchased camera 3 (alternatively, the camera 3 purchased without going through the marketplace may be used) in any place such as a store managed by the user, and in order to maximize the function of each camera 3, information of the installation place of the camera 3 can be registered in the marketplace.

On the right side of the user screen G3, radio buttons 98 capable of selecting environment information regarding the environment in which the camera 3 is installed are arranged. Examples of the environment information selectable as illustrated in the drawing include an installation place and a type of a position of the camera 3, a type of a subject to be imaged, a processing time, and the like.

The user can cause the above-described optimum imaging setting to be set in the target camera 3 by appropriately selecting the environment information regarding the environment in which the camera 3 is installed.

Note that, in a case where the installation place of the camera 3 to be purchased is determined together with the purchase of the camera 3, it is possible to purchase the camera 3 in which optimal imaging setting is set in advance according to the installation scheduled place by selecting each item on the left side and each item on the right side of the user screen G3.

Furthermore, an execution button 99 is provided on the user screen G3 for the user. By pressing the execution button 99, the screen transitions to a confirmation screen for confirming the purchase or a confirmation screen for confirming the setting of the environment information. Thus, the user can purchase a desired camera 3 or a desired fog server 4, and can set environment information for the camera 3.

In the marketplace, it is possible to change the environment information of each camera 3 for when the installation place of the camera 3 is changed. By re-inputting the environment information about the installation place of the camera 3 on a change screen (not illustrated), it is possible to re-set the optimum imaging setting for the camera 3.

### 2. AI Model Test as Embodiment

### (2-1. System Configuration Example)

As described above, in the present embodiment, it is assumed that a test for the AI model handled by the information processing system SY described above is performed as a test of the AI model. Specifically, in the present example, it is assumed that the AI model developer tests his/her developed AI model.

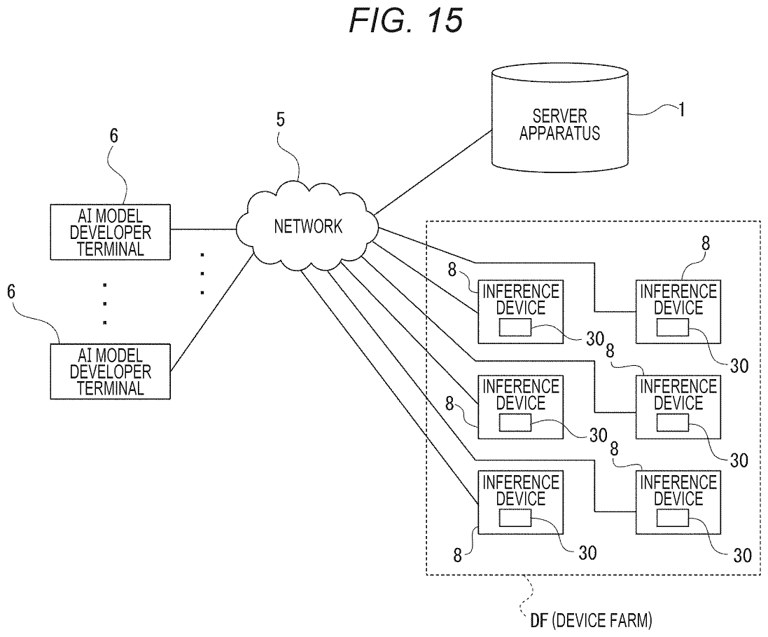

FIG. 15 is a block diagram illustrating a configuration example of a model test system which is a system for providing a test function of an AI model as an embodiment.

Note that, in the following description, the same reference signs are given to portions similar to those already described, and description thereof is omitted.

As illustrated, the model test system includes one or a plurality of AI model developer terminals 6, a server apparatus 1, and one or a plurality of inference devices 8.

As described above, the AI model developer terminal 6 is an information processing apparatus such as a PC used by the AI model developer. In the present example, since the AI model developer tests the AI model developed by the AI model developer using the model test system, the AI model developer is positioned as a user as a system user.

The server apparatus 1 is configured as an information processing apparatus (computer apparatus) including a microcomputer including a CPU, a ROM, and a RAM, and executes various types of control processing related to the test of the AI model.

In the present example, the hardware configuration of the computer apparatus as the server apparatus 1 is similar to that illustrated in FIG. 5 above. Hereinafter, the CPU 11 included in the computer apparatus as the server apparatus 1 is referred to as “CPU 11-1”.

The server apparatus 1 can mutually perform data communication with the AI model developer terminal 6 and the inference device 8 via the network 5.

Here, the server apparatus 1 may be the same device as the server apparatus 100 in the information processing system SY. That is, there may be a configuration in which a device that performs various types of control processing related to the test of the AI model and a device that performs management processing of the information processing system SY are the same device.

The inference device 8 is a device that performs inference processing for a test, and is configured to be capable of executing inference processing using an AI model.

In the present embodiment, it is assumed that the AI model handled by the information processing system SY is tested, in other words, the image sensor 30 (AI processing unit 44) mounted on the camera 3 is tested for the AI model to be used for the inference processing, and thus the inference device 8 is provided with the image sensor 30 of the same model (same configuration) as the image sensor 30 mounted on the camera 3.

Therefore, it is possible to test an AI model using an actual machine instead of a simulator.

In the present embodiment, the inference device 8 is not prepared by the AI model developer, but prepared by a service provider that provides the user with the test function of the AI model. That is, the model test system of the present embodiment provides a test environment in which the AI model developer can perform an AI model test without preparing the inference device 8 by himself/herself.

In the present embodiment, the plurality of inference devices 8 is arranged in a place called a device farm DF. In the present example, the region where the inference device 8 is arranged is a region remote from the region where the server apparatus 1 is arranged, for example, a country different from the country where the server apparatus 1 is arranged.

Thus, the inference device 8 can be arranged in a region where cost related to arrangement and management is low, and cost related to the test can be reduced.

Note that arranging the inference device 8 in a region different from the server apparatus 1 is merely an example, and there may be a case where the inference device 8 is arranged close to the server apparatus 1, such as being arranged in the same room as the server apparatus 1.

The reason why the plurality of inference devices 8 is arranged in the device farm DF is to allow a plurality of AI model developers to test AI models simultaneously in parallel. Specifically, the server apparatus 1 according to the present embodiment performs the assignment processing of the inference device 8 to be used for the test so as to achieve load distribution among the inference devices 8 in response to test requests of AI models from the plurality of AI model developer terminals 6.

### (2-2. Configuration Example of Inference Device)

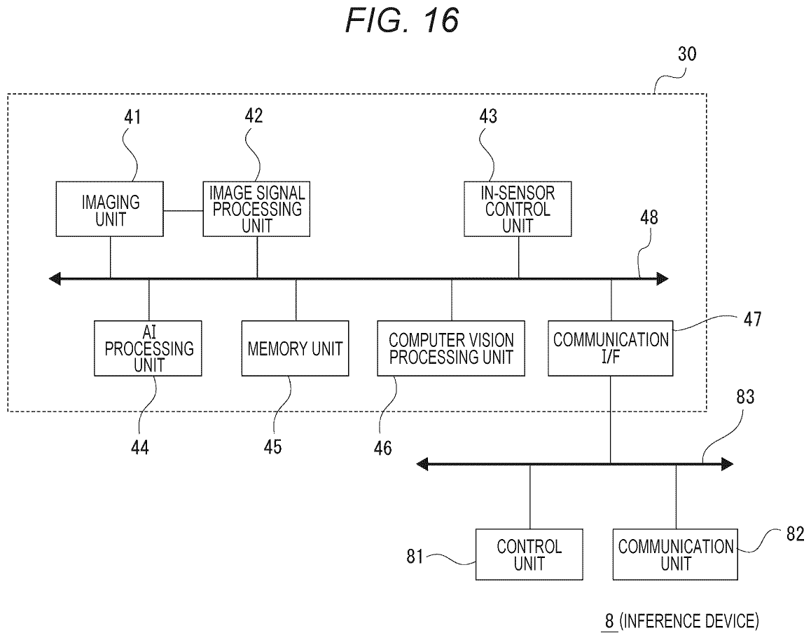

FIG. 16 is a block diagram illustrating a configuration example of the inference device 8.

As illustrated, the inference device 8 includes an image sensor 30 and also includes a control unit 81, a communication unit 82, and a bus 83. The image sensor 30, the control unit 81, and the communication unit 82 are connected via the bus 83, and can perform data communication with each other.

The communication unit 82 performs data communication with an external apparatus via the network 5, particularly data communication with the server apparatus 1 in present example.

The control unit 81 includes, for example, a microcomputer including a CPU, a ROM, and a RAM, and performs overall control of the inference device 8 by the CPU executing various processes according to a program stored in the ROM or a program loaded in the RAM. For example, processing related to data communication with an external apparatus such as the server apparatus 1 is performed, such as transferring data received from the external apparatus such as the server apparatus 1 via the communication unit 82 to the image sensor 30 or causing data such as, for example, an inference result obtained by the image sensor 30 to be transmitted to the external apparatus such as the server apparatus 1 via the communication unit 82.

Furthermore, in particular, the control unit 81 in the present embodiment also performs processing related to an AI model test method as an embodiment on the basis of an instruction from the server apparatus 1, and this will be described again below.

### (2-3. Example of AI Model Test Method)

In the present embodiment, the server apparatus 1 performs various types of processing related to the test of the AI model.

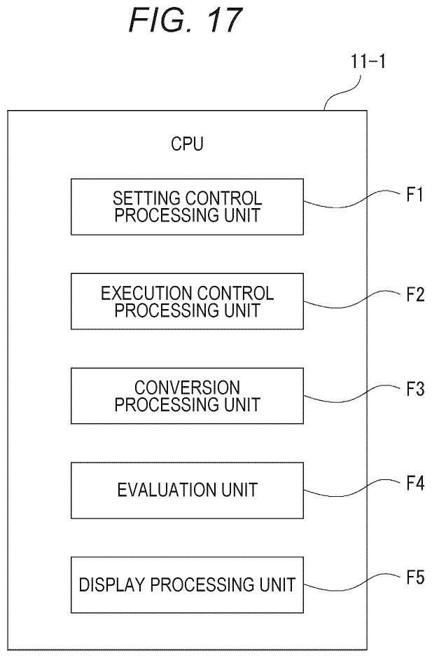

FIG. 17 is a functional block diagram for describing a function related to a test of an AI model included in the CPU 11-1 of the server apparatus 1.

As illustrated, the CPU 11-1 has functions as a setting control processing unit F1, an execution control processing unit F2, a conversion processing unit F3, an evaluation unit F4, and a display processing unit F5.

The display processing unit F5 performs processing of displaying various types of information related to the test of the AI model on the display unit 17 of the AI model developer terminal 6.

Here, in the present embodiment, the GUI for performing various operations related to the test of the AI model is displayed on the display unit 17 of the AI model developer terminal 6, and the control processing for causing the inference device 8 to execute the inference processing as a test on the basis of the operation of the AI model developer is executed by the server apparatus 1. Specifically, in the present embodiment, the AI model developer launches a test application on the AI model developer terminal 6 and performs an operation on a GUI presented by the application to thereby give an instruction to execute the test of the AI model, and regarding this test application, a software as a service (SaaS) type is adopted in which software (software program) as the test application is stored on the server apparatus 1 side and the software is provided as a service.

The setting control processing unit F1 performs processing of causing the inference device 8 to set a designated model that is an AI model designated by the user.

Furthermore, the execution control processing unit F2 performs processing of causing the inference device 8 in a state in which the designated model is set to execute inference processing using data designated by the user as inference target data.

By the setting control processing unit F1 and the execution control processing unit F2 as described above, since the inference processing is executed by the inference device 8 for the data designated by the user, in order to implement a test simulating an assumed use environment as a test of the AI model, it is sufficient if the user prepares and designates data acquired in the use environment in advance, and it is not necessary to actually place the inference device 8 in the assumed use environment or an environment simulating the assumed use environment at the time of the test. Specifically, by adopting a method of inputting data designated by the user to the inference device 8, it is not necessary to prepare the image sensor 30 (sensing device) for obtaining the inference target data and perform sensing in the test environment. In a case where sensing for obtaining the inference target data is performed in the test environment, the sensing device and the inference device 8 are placed in the assumed use environment or in the environment simulating the assumed use environment in order to implement the test simulating the assumed use environment, but since it is not necessary to perform sensing in the test environment by adopting the method using user-designated data as the inference target data as described above, it is not necessary to actually place the inference device 8 in the assumed use environment or a simulated environment thereof at the time of the test.

In the test of the AI model, it is not necessary to place the inference device in a specific environment such as the assumed use environment or the simulated environment thereof, so that cost reduction is achieved. Furthermore, in a case where a plurality of use environments is tested, it is not necessary to prepare the inference device 8 (device farm DF) for each use environment, and thus cost reduction is also achieved in this respect.

Then, in the present embodiment, in the test of the AI model, an inference device as an actual machine is used instead of a simulator. Therefore, test accuracy can be improved.

As described above, according to the present embodiment, in a case where the test of the AI model simulating the assumed use environment of the user is performed, it is possible to improve the test accuracy and reduce cost related to the test.

Note that, by using the inference device 8 as an actual machine instead of the simulator, it is possible to perform a highly accurate test even on an item that is difficult to test by the simulator, for example, a device heat generation amount at the time of inference processing.

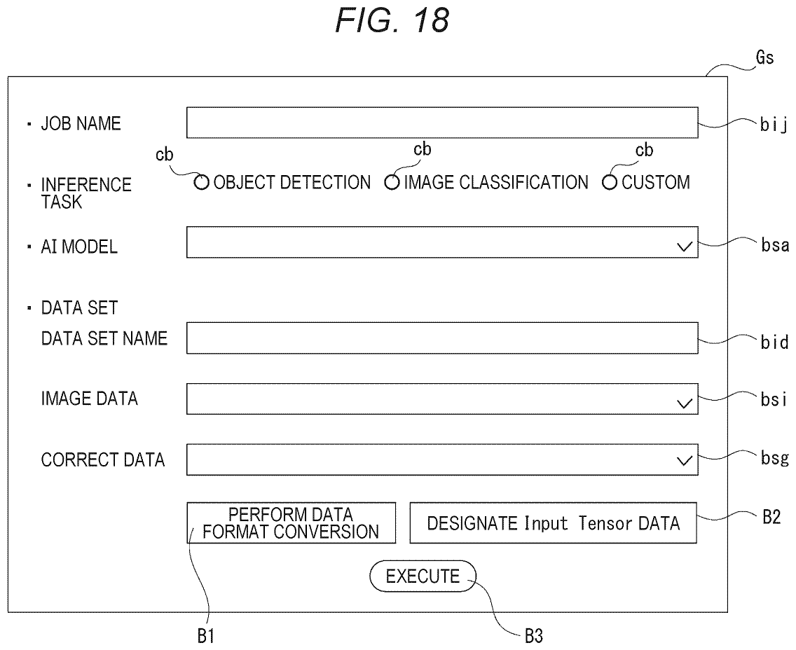

A specific procedure example related to the designation of the AI model to be used for the test and the designation of the inference target data will be described with reference to FIG. 18.

FIG. 18 illustrates an example of a setting screen Gs for the user as the AI model developer to perform various settings related to the test of the AI model.

The setting screen Gs is displayed on the display unit 17 of the AI model developer terminal 6 by the test application described above.

As illustrated in the drawing, the setting screen Gs includes a job name input box bij for inputting a job name regarding the test of the AI model, a plurality of check boxes cb for designating the type of the inference task executed by the AI model as a test target from a plurality of candidates, a model designation box bsa for designating AI model data regarding the AI model as a test target, a data set name input box bid for inputting the name of a data set to be used for the test, an image data designation box bsi for designating image data constituting the data set, that is, image data as target data of inference processing, a correct data designation box bsg for designating correct data (Ground Truth) constituting the data set, a conversion instruction button B1 for instructing conversion of the target data of the inference processing into an input tensor data format of the AI model, a designation instruction button B2 for designating data in a case where the user prepares data in the input tensor data format as the target data of the inference processing, and an execution button Bs for giving an execution instruction of the test are provided.

In the job name input box bij and the data set name input box bid, name information by text can be input, and a user can set any name information for the job name and the data set name.

In the present example, three check boxes cb corresponding to three items of object detection, image classification, and custom are provided as the check boxes cb. Inference tasks of the object detection and the image classification are inference tasks that allow the test application to display results on a test result screen Gr as described later, and in a case where the check boxes cb of the object detection and image classification are checked, corresponding test results are displayed on the test result screen Gr.

On the other hand, the custom means an inference task that does not correspond to display of a result on the test result screen Gr by the test application. In the present example, in a case where the custom check box cb is checked, the test result screen Gr is not displayed, and the test result is displayed in another format.

Note that a specific example of the test result display in another format will be described later.

In the model designation box bsa, a list of storage destination information of AI model data prepared in advance by the user is displayed by a pull-down operation, and the user can designate AI model data for the AI model to be tested from the list.

In the present example, as the storage destination of the AI model data, a directory outside the AI model developer terminal 6 can be designated in addition to a local directory of the AI model developer terminal 6.

In the image data designation box bsi and the correct data designation box bsg, similarly to the model designation box bsa described above, lists of image data prepared in advance as a test data set by the user and storage destination information of the correct data are displayed by a pull-down operation, and the image data to be used for the test and the correct data can be designated from the list.

It is conceivable that not only the local directory of the AI model developer terminal 6 but also a directory outside the AI model developer terminal 6 can be designated as the storage destination of the image data and the correct data.

Here, in a case where data in the input tensor data format of the AI model as a test target is not prepared for the test image data, the user can instruct to execute data format conversion to the input tensor data format for the image data designated in the image data designation box bsi by operating the conversion instruction button B1. As the data format conversion here, for example, conversion of color information such as conversion of an image size, conversion of an aspect ratio, and conversion from RGB to YUV is a representative example.

Note that, although not illustrated, detailed settings of data format conversion can be received on the setting screen Gs. That is, a GUI for performing specific designation of the image size, aspect ratio, color information, and the like described above is displayed.

In a case where the user prepares data in the input tensor data format as the target data of the inference processing and desires to use the data in the input tensor data format for the test, the user operates the designation instruction button B2. Although not illustrated, when the designation instruction button B2 is operated, storage destination information of data in the input tensor data format prepared by the user for a test is displayed in a list on the setting screen Gs, and the user can designate data to be used for the test from the list.

Note that, on the setting screen Gs, even in a case where the user operates the designation instruction button B2 to designate data in the input tensor data format, the user can designate the image data in the image data designation box bsi. This is because the image data designated in the image data designation box bsi is used for image display in the inference result image display area Ari on the test result screen Gr as described later.

The setting control processing unit F1 in the present example performs processing of causing the inference device 8 to set the AI model (designated model) designated by the user on the setting screen Gs as described above.

Specifically, the setting control processing unit F1 deploys the AI model data stored in the storage destination designated by the user in the model designation box bsa to the target inference device 8 so that the inference device 8 can execute the inference processing by the designated model.

Here, as described above, the server apparatus 1 of the present example can receive a test request (in the present example, the operation of the execution button Bs described above is performed) of the AI model from the plurality of AI model developer terminals 6. Then, in a case where test requests from the plurality of AI model developer terminals 6 are received, the server apparatus 1 (the CPU 11-1) performs processing of selecting the inference device 8 to be used for the test so as to achieve load distribution of the inference device 8.

The above-described “target inference device 8” corresponds to the inference device 8 selected by the processing in a state where the test requests from the plurality of AI model developer terminals 6 is received. Note that in a state where a test request is made only from the single AI model developer terminal 6, the “target inference device 8” only needs to be, for example, the inference device 8 arbitrarily selected by the CPU 11-1.

The execution control processing unit F2 performs processing of causing the target inference device 8 to execute the inference processing using the data specified by the user on the setting screen Gs as the inference target data.

Specifically, in a case where image data is designated in the image data designation box bsi and the conversion instruction button B1 is operated, the execution control processing unit F2 transmits, to the inference device 8, data obtained by the conversion processing into the input tensor data format for the designated image data, and instructs the inference device 8 to execute the inference processing using the data as input data of the AI model (designated model).

Here, the conversion processing into the input tensor data format is performed by the conversion processing unit F3 illustrated in FIG. 17. That is, the conversion processing unit F3 performs processing of converting data designated by the user into the input tensor data format of the designated model.

Furthermore, in a case where the designation instruction button B2 is operated and data in the input tensor data format is designated, the execution control processing unit F2 transmits data in the designated input tensor data format to the inference device 8 and instructs the inference device 8 to execute inference processing using the data as input data of the AI model.

In FIG. 17, the evaluation unit F4 receives inference result information by the designated model from the inference device 8 and evaluates inference performance. Specifically, the evaluation unit F4 evaluates the inference performance on the basis of the correct data of the inference designated by the user. That is, the evaluation unit F4 of the present example evaluates the inference performance for the designated model on the basis of the correct data designated by the user in the correct data designation box bsg on the setting screen Gs.

The display processing unit F5 performs processing of displaying evaluation result information by the evaluation unit F4 on the display unit 17 of the AI model developer terminal 6. Here, the AI model developer terminal 6 can be rephrased as a user terminal device that displays information for the user (user related to the test of the AI model).

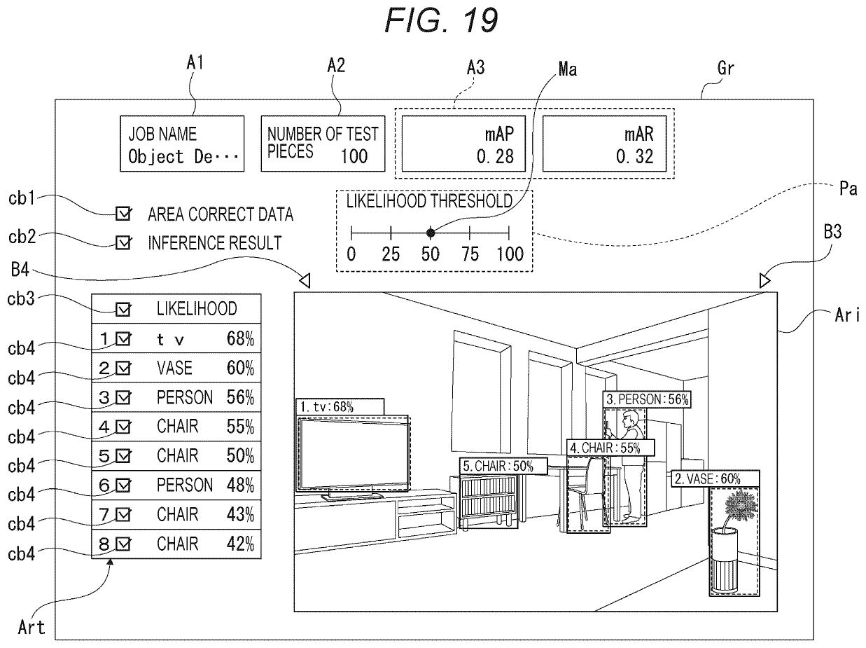

The display processing unit F5 in the present example performs processing of displaying the test result screen Gr illustrated in FIG. 19 on the display unit 17 of the AI model developer terminal 6.

As illustrated, the test result screen Gr is provided with a job name display area A1, a number of test pieces display area A2, an evaluation value display area A3, an inference result text display area Art, an inference result image display area Ari, check boxes cb1 and cb2, a forward feed button B3, a reverse feed button B4, and a designation reception unit Pa.

In the job name display area A1, information of the job name input in the job name input box bij on the setting screen Gs is displayed.

The number of test pieces display area A2 is an area for displaying the number of images used for testing the AI model, that is, the number of images for which inference processing as a test is executed on the AI model as a designated model, and specifically, the number of image data designated in the image data designation box bsi of the setting screen Gs or the number of input tensor data designated by operating the designation instruction button B2 is displayed.

The evaluation value display area A3 is an area in which the evaluation unit F4 displays evaluation values Ev calculated on the basis of the inference result information by the designated model and the correct data.

In the present example, the evaluation unit F4 can calculate mean average precision (mAP) and mean average recall (mAR) as the evaluation values Ev.

The evaluation values Ev as mAP and mAR are evaluation values Ev calculated in a case where the designated model performs object detection processing and object recognition processing (with classification of the object), that is, in a case where the object detection and the image classification are designated by the check boxes cb on the setting screen Gs and in a case where the designated model performs object recognition processing, that is, in a case where only the image classification is designated by the check box cb on the setting screen Gs, mAP is a value obtained by averaging the average precision (AP) for each class of the object, and mAR is a value obtained by averaging the average recall (AR) for each class of the object.

In a case where the evaluation unit F4 calculates the evaluation values Ev as mAP and mAR, the display processing unit F5 displays numerical information of mAP and mAR in the evaluation value display area A3.

FIG. 19 illustrates an example of the test result screen Gr corresponding to a case where the object detection and the image classification are designated on the setting screen Gs, and numerical information of mAP and mAR is displayed in the evaluation value display area A3 as illustrated.

Note that, in a case where the inference task of the designated model is only the object detection processing and only the object detection is designated by the check box cb on the setting screen Gs, it is conceivable that the evaluation unit F4 calculates AP, AR, Intersection Over Union (IOU), and the like based on the correct data of the bounding box as evaluation values Ev, and the display processing unit F5 displays these AP, AR, and IOU in the evaluation value display area A3.

Note that, regarding the evaluation values Ev of the inference performance, the above-described example is merely an example, and for example, it is also conceivable to adopt other evaluation values such as accuracy (accuracy rate) and F value (F-measure).

The inference result text display area Art is an area in which text information indicating the inference result is displayed in a case where at least the image classification is designated on the setting screen Gs. Specifically, in the inference result text display area Art, name information of classes of objects recognized by the inference processing as the image recognition processing performed by the designated model and information of likelihood thereof are displayed. In the present example, the name information of the recognized classes are displayed in descending order of likelihood values.

The inference result image display area Ari is an area in which image display is performed at least in a case where object detection is designated on the setting screen Gs, and is an area in which an image in which a bounding box (rectangular frame indicating an object detection area) indicating an inference result by the object detection processing is superimposed on an image used for a test (hereinafter referred to as “test image”) as the inference target data is displayed. For confirmation, the display processing unit F5 uses the image designated in the image data designation box bsi of the setting screen Gs as the test image to be displayed in the inference result image display area Ari.

FIG. 19 illustrates an example corresponding to a case where the object detection and the image classification are designated on the setting screen Gs as an example of the display image of the inference result image display area Ari. In this case, in the inference result image display area Ari, the bounding box of a detected object and the correct data of the bounding box are superimposed and displayed on the test image, and the name information of the class of the recognized object, likelihood information, and information of rank according to the likelihood are displayed on the bounding box.

As described above, the display processing unit F5 in the present example performs processing of displaying detection result information of an object area by the inference processing and correct information thereof on the display unit 17 of the AI model developer terminal 6.

Thus, as the performance evaluation of the AI model that performs the class identification and the area detection on an object, not only an evaluation result regarding whether the class identification is correct or incorrect but also an evaluation result from the viewpoint of whether the object area has been correctly detected can be visually presented to the user. At this time, with respect to the evaluation result of object area detection, an error between the detection result information of the object area and the correct information thereof can be visually presented to the user, and the user can intuitively recognize an error between the detection area and a correct area.

Here, in the test result screen Gr of the present example, a check box cb3 as illustrated in the drawing is provided in the inference result text display area Art, and on/off of display of the rank, the class name, and the likelihood in the bounding boxes is switched in the inference result image display area Ari according to the presence or absence of the check on the check box cb3.

Furthermore, in the inference result text display area Art of the present example, a check box cb4 is provided for each recognized object in the list of name information of the class of a recognized object, and the presence or absence of the bounding box for the recognized object is switched in the inference result image display area Ari according to the presence or absence of the check on the check box cb4.

Furthermore, the test result screen Gr of the present example is provided with a check box cb1 for switching the presence or absence of display of the bounding box as correct data and a check box cb2 for switching the presence or absence of display of the bounding box of a detected object in the inference result image display area Ari. In a case where the check box cb2 is unchecked, all the bounding boxes that have been displayed are switched to non-display in the inference result image display area Ari.

The test result screen Gr is provided with a forward feed button B3 and a reverse feed button B4 for switching from display of a test result of a certain image to display of a test result of a different image in a case where the inference processing for each of the plurality of images is executed by the designated model.

In a case where the forward feed button B3 or the reverse feed button B4 is operated, the display processing unit F5 performs processing of displaying, in the evaluation value display area A3, the evaluation value Ev calculated by the evaluation unit F4 from an inference result (and correct data) for an image (switching destination image) specified by a feed direction of an operated button, which is either the forward feed button B3 or the reverse feed button B4. Furthermore, in a case where the forward feed button B3 or the reverse feed button B4 is operated, the display processing unit F5 performs processing of switching the display information of the inference result text display area Art and the inference result image display area Ari to the information indicating the inference result for the switching destination image described above.

The designation reception unit Pa is a display object that receives an operation of designating a threshold (hereinafter referred to as “threshold Th”) for the likelihood of the inference result. The designation reception unit Pa in the present example is provided with a designation operation element Ma for designating the threshold Th, and the user can designate a threshold of the likelihood by operation of the designation operation element Ma. Although the drawing illustrates an example in which the designation operation element Ma is a slider type operation element, an operation element in another form such as a rotary type operation element can also be adopted. Furthermore, it is also conceivable to adopt another method such as a method of directly inputting a numerical value instead of designation of the threshold of the likelihood by operation of an operation element.

The display processing unit F5 performs processing of displaying, on the test result screen Gr, only an inference result of which the likelihood is equal to or greater than the threshold Th as an inference result by the designated model. Specifically, in the present example, processing of displaying the detected bounding box and the bounding box as the correct data is performed only for the recognized object of which the likelihood is equal to or greater than the threshold Th in the inference result image display area Ari.

Thus, in a case where the inference result is displayed on the display screen of the test result, in a case where the performance of the designated model is low and the likelihood of the inference result is low, increasing the threshold Th makes it difficult to display the inference result. Conversely, in a case where the performance of the designated model is high and the likelihood of the inference result is high, the inference result is easily displayed without decreasing the threshold Th. By performing such control of display/non-display of the inference result according to a threshold Th of the likelihood, it is possible to enable the user to intuitively recognize whether or not the inference result with the likelihood desired by the user has been obtained by the display/non-display of the inference result, and it is possible to improve the grasping easiness of the test result.

Here, the display processing unit F5 according to the present embodiment is capable of selectively executing processing of causing the AI model developer terminal 6 to display the evaluation result information by the evaluation unit F4 and processing of causing the AI model developer terminal 6 to display visualized data of the inference processing result by the designated model.

Specifically, in the present example, the test application has a function of calculating the evaluation value Ev based on inference results of the object detection (object detection processing) and the image classification (object recognition processing), but does not have a function of calculating the evaluation value Ev for the custom (object detection processing and inference processing other than object recognition processing). Therefore, in a case where at least one of the object detection or the image classification is designated on the setting screen Gs, the display processing unit F5 performs processing of causing the display unit 17 of the AI model developer terminal 6 to display a screen including display of the evaluation value Ev calculated by the evaluation unit F4 on the basis of the inference result by the designated model, such as the test result screen Gr illustrated in FIG. 19.

On the other hand, in a case where the custom is designated on the setting screen Gs, the display processing unit F5 performs processing of generating text data obtained by converting the inference result information into text in a predetermined file format such as a JavaScript Object Notation (JSON) format, for example, and displaying the text data on the display unit 17 of the AI model developer terminal 6.

By performing the processing as described above, it is possible to display information indicating a test result even in a case where the inference task of the designated model is an inference task for which evaluation calculation is impossible.

Therefore, the correspondence range of the AI model capable of displaying the test result is widened, and the convenience of the user can be improved.

### (2-4. Processing Procedure)

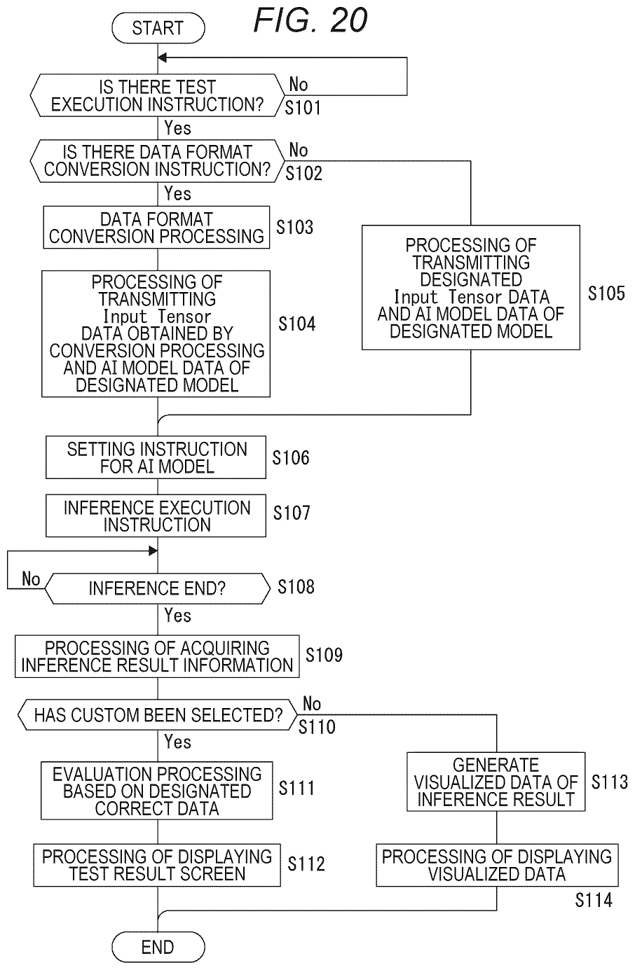

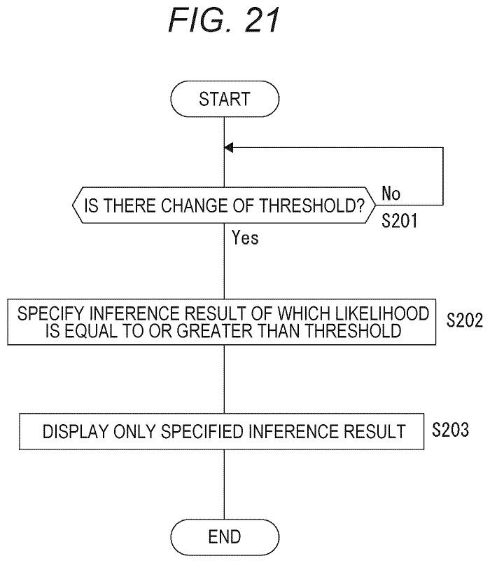

An example of a specific processing procedure for implementing the AI model test method as the embodiment described above will be described with reference to flowcharts of FIGS. 20 and 21.

FIG. 20 is a flowchart illustrating an example of a series of processing corresponding to processing from a test execution instruction to display of a test result.

In the present example, the processing illustrated in FIG. 20 is executed by the CPU 11-1 of the server apparatus 1 on the basis of, for example, a program stored in the ROM 12, the storage unit 19, or the like of the server apparatus 1.

When the processing illustrated in FIG. 20 is performed, it is assumed that various types of information have already been designated on the setting screen Gs by the user.

First, in step S101, the CPU 11-1 waits for a test execution instruction. That is, it waits for the operation of the execution button Bs on the setting screen Gs.

In a case where it is determined in step S101 that the execution button Bs is operated and there is a test execution instruction, the CPU 11-1 proceeds to step S102 and determines whether or not there is a data format conversion instruction. That is, it is determined whether or not the conversion instruction by the conversion instruction button B1 has been performed on the setting screen Gs.

In a case where it is determined that the conversion instruction is issued by the conversion instruction button B1 and the data format conversion instruction is issued, the CPU 11-1 proceeds to step S103 and executes data format conversion processing. That is, processing of converting the image data designated in the image data designation box bsi of the setting screen Gs into data in the input tensor data format of the designated model (hereinafter referred to as “input tensor data”) is performed.

Then, in step S104 subsequent to step S103, the CPU 11-1 performs processing of transmitting the input tensor data obtained in the conversion processing in step S103 and the AI model data of the designated model designated on the setting screen Gs to the target inference device 8 as processing of transmitting the input tensor data obtained in the conversion processing and the AI model data of the designated model.

On the other hand, in a case where it is determined in step S102 that the conversion instruction by the conversion instruction button B1 has not been performed and the data format conversion instruction has not been performed, the CPU 11-1 proceeds to step S105 and performs processing of transmitting the input tensor data designated by the operation of the designation instruction button B2 on the setting screen Gs and the AI model data of the designated model, that is, processing of transmitting the input tensor data and the AI model data to the target inference device 8.

In response to the execution of the transmission processing in step S104 or S105, the CPU 11-1 proceeds to step S106, gives a setting instruction for the AI model to the target inference device 8, and then gives an inference execution instruction in step S107. Specifically, in the inference execution instruction in step S107, an instruction to execute the inference processing using the input tensor data transmitted in step S104 or S105 as the inference target data is performed as the inference processing using the AI model for which the setting instruction has been given.

Here, in the target inference device 8, in response to the instructions in steps S106 and S107 described above, the control unit 81 performs control to cause the image sensor 30 (AI processing unit 44) to execute the inference processing according to these instructions.

As can also be understood from this point, the control unit 81 performs processing of setting a designated model, which is an AI model designated by the user and transmitted from the server apparatus 1 (external apparatus), as an AI model used by the AI processing unit 44 (inference unit), and causing the AI processing unit 44 in a state in which the designated model has been set to execute inference processing using data designated by the user and transmitted from the server apparatus 1 as inference target data.

Note that, in a case where a mode in which every predetermined number of pieces, such as every piece, of a plurality of pieces of the input tensor data is subjected to the inference processing, is adopted as a test mode of the designated model, it is also conceivable that the input tensor data is transmitted to the inference device 8, for example, a part of the input Tensor data used for the test is sequentially transmitted one by one every time the inference processing for the one piece of the input tensor data is completed.

In response to performing the inference execution instruction in step S107, the CPU 11-1 proceeds to step S108 and waits for the end of the inference. That is, the inference device 8 waits until the inference processing as a test is completed.

In a case where it is determined in step S108 that the inference processing has ended, the CPU 11-1 proceeds to step S109 and performs processing of acquiring the inference result information from the inference device 8.

In step S110 following step S109, the CPU 11-1 determines whether or not the custom has been selected. That is, on the setting screen Gs, it is determined whether the custom is designated by the check box cb or at least one of object detection or image classification is designated without designating the custom.

In a case where it is determined in step S110 that at least one of object detection or image classification is designated and the custom is not selected, the CPU 11-1 proceeds to step S111 and executes the evaluation processing based on the designated correct data. That is, processing of calculating the evaluation value Ev on the basis of the correct data designated in the correct data designation box bsg on the setting screen Gs and the inference result information acquired in step S109 is executed. Note that, since a specific example of the calculation of the evaluation value Ev has already been described, redundant description is avoided.

In step S112 following step S111, the CPU 11-1 performs processing of displaying the test result screen Gr on the display unit 17 of the AI model developer terminal 6 as the display processing of the test result screen Gr. Note that the specific description of what kind of display information is to be displayed as the test result screen Gr has already been given, and thus duplicate description is avoided.

On the other hand, in a case where it is determined in step S110 that the custom is designated, the CPU 11-1 proceeds to step S113 and generates visualized data of the inference result. Specifically, processing of generating text data in which the inference result information acquired in step S109 is converted into text in a predetermined file format such as JSON format is performed.

Then, in step S114 following step S113, the CPU 11-1 performs processing of displaying the above-described textual data on the display unit 17 of the AI model developer terminal 6 as processing of displaying the visualized data.

The CPU 11-1 ends the series of processes illustrated in FIG. 20 in response to the execution of the processing of step S112 or S114.

Note that, in a case where the test mode in which every predetermined number of pieces, such as every piece, of a plurality of pieces of the input tensor data is subjected to the inference processing, is adopted, it is conceivable that the acquisition processing in step S109 is performed as processing of acquiring result information every time the inference processing of the predetermined number of pieces ends, for example, acquiring result information every time the inference processing for one piece of input tensor data ends in the inference device 8. In this case, it is conceivable to execute the evaluation processing in step S111 and the visualized data generation processing in step S113 every time the inference result information of the predetermined number of pieces is obtained.

FIG. 21 is a flowchart illustrating an example of processing related to display control according to an operation of changing the threshold Th.

In the present example, similarly to the processing of FIG. 20 described above, the CPU 11-1 of the server apparatus 1 also executes the processing illustrated in FIG. 21 on the basis of, for example, a program stored in the ROM 12, the storage unit 19, or the like of the server apparatus 1.

Furthermore, when the processing illustrated in FIG. 21 is executed, it is assumed that the test result screen Gr is already displayed on the AI model developer terminal 6, and the CPU 11-1 repeatedly executes the processing illustrated in FIG. 21 while the test result screen Gr is displayed.

In step S201, the CPU 11-1 waits for the change of the threshold Th. Specifically, in the present example, the processing waits until the operation of changing the threshold Th is performed by the designation operation element Ma described above.

In a case where it is determined in step S201 that the threshold Th has been changed, the CPU 11-1 proceeds to step S202, performs processing of specifying an inference result of which the likelihood is equal to or greater than the threshold Th, and further performs processing of displaying only the specified inference result in subsequent step S203. Specifically, in the present example, processing of displaying the detected bounding box and the bounding box as the correct data is performed only for the recognized object of which the likelihood is equal to or greater than the threshold Th in the inference result image display area Ari.

In response to the execution of the processing of step S203, the CPU 11-1 terminates the series of processes illustrated in FIG. 21.

### 3. Modifications

Note that the embodiment is not limited to the specific examples described above, and may be configured as various modifications.

For example, in the above description, as an example of the image data, data (pixel data) of each pixel has been exemplified as data indicating the amount of received light (luminance value), but in the present technology, the image data is a generic term for data including a plurality of pieces of pixel data. The pixel data mentioned here widely includes not only data indicating the amount of light received from the subject but also, for example, data indicating the distance to the subject, polarization information, temperature, and the like. That is, the image data in the present technology widely includes data as a gradation image indicating information on the amount of received light for each pixel, data as a distance image indicating information on the distance to the subject for each pixel, data as a polarized image indicating polarization information for each pixel, data as a thermal image indicating temperature information for each pixel, and the like.

Furthermore, in the above description, the image data has been exemplified as an example of the inference target data, but the present technology can also be suitably applied to a case where data other than the image data, such as sound data, acceleration data, and angular velocity data, is used as the inference target data.

Furthermore, in the above description, an example has been described in which the processing as the designation control processing unit F1 and the execution control processing unit F2 and the processing as the conversion processing unit F3 are performed by the same apparatus (server apparatus 1), but a configuration in which these processing are performed by different apparatuses can also be adopted.

Moreover, in the above description, an example has been described in which the processing as the designation control processing unit F1 and the execution control processing unit F2 and the processing as the evaluation unit F4 are performed by the same apparatus, but a configuration in which these processing are performed by different apparatuses can also be adopted.

For example, it is conceivable that the server apparatus 1 performs the processing as the designation control processing unit F1 and the execution control processing unit F2, and the processing as the conversion processing unit F3 and the evaluation unit F4 is performed by an apparatus (excluding the AI model developer terminal 6) different from the server apparatus 1.

Moreover, in the above description, an example has been described in which the processing as the designation control processing unit F1 and the execution control processing unit F2 and the processing as the display processing unit F5 are performed by the same apparatus, but a configuration in which these processing are performed by different apparatuses can also be adopted. For example, the former processing may be performed by the server apparatus 1, and the latter processing may be performed by the AI model developer terminal 6.

### 4. Summary of Embodiment

As described above, an information processing apparatus (server apparatus 1) as an embodiment includes: a setting control processing unit (F1) that causes an inference device that performs inference processing using an AI model to set a designated model that is an AI model designated by a user; and an execution control processing unit (F2) that causes the inference device in a state in which the designated model has been set to execute inference processing using data designated by the user as inference target data.

According to the above configuration it is possible to provide the user with an environment for testing the AI model using the inference device as an actual machine instead of a simulator as a test environment of the AI model. Furthermore, since the inference processing is executed by the inference device on the data designated by the user, in order to implement a test simulating an assumed use environment as a test of the AI model, it is sufficient if the user prepares data acquired in the use environment in advance and designates the data, and it is not necessary to actually place the inference device under the assumed use environment or an environment simulating the assumed use environment at the time of the test. Specifically, by adopting a method of inputting data designated by the user to the inference device, it is not necessary to prepare a sensing device such as an image sensor or a microphone for obtaining inference target data and perform sensing in the test environment. In a case where sensing for obtaining the inference target data is performed in the test environment, the sensing device and the inference device are placed in the assumed use environment or in the environment simulating the assumed use environment in order to implement the test simulating the assumed use environment, but since it is not necessary to perform sensing in the test environment by adopting the method using user-designated data as the inference target data as described above, it is not necessary to actually place the inference device in the assumed use environment or a simulated environment thereof at the time of the test. In the test of the AI model, it is not necessary to place the inference device in a specific environment such as the assumed use environment or the simulated environment thereof, so that cost reduction is achieved. Furthermore, in a case where a plurality of use environments is tested, it is not necessary to prepare an inference device for each use environment, so that cost reduction is also achieved in this respect.

Therefore, in a case where the AI model simulating the assumed use environment of the user is tested, it is possible to improve the test accuracy and reduce cost related to the test.

Furthermore, the information processing apparatus as an embodiment includes a conversion processing unit (F3) that converts data designated by the user into an input tensor data format of the designated model.

For the target data of the inference processing, the user does not necessarily prepare data in the input tensor data format of the AI model for testing. By including the conversion processing unit as described above, the degree of freedom of data prepared by the user for implementing the test of the AI model increases, and it is possible to reduce the burden when preparing data.

Moreover, the information processing apparatus as an embodiment includes an evaluation unit (F4) that receives inference result information by the designated model from the inference device and evaluates inference performance.

Thus, it is possible to implement a test regarding inference performance for the target AI model.

Moreover, in the information processing apparatus as an embodiment, the evaluation unit evaluates the inference performance on the basis of correct data of inference designated by a user.

By performing an evaluation based on the inference result and the correct data, it is possible to improve the evaluation accuracy of the inference performance.

Furthermore, the information processing apparatus as an embodiment includes a display processing unit (F5) that performs processing of displaying evaluation result information by the evaluation unit on a user terminal device that displays information for the user.

Thus, the evaluation result information as test result information regarding the designated model can be visually presented to the user, and the user can be made to recognize the test result.

Moreover, in the information processing apparatus as an embodiment, the display processing unit performs processing of displaying a designation reception unit (Pa) that receives an operation of designating a threshold for likelihood of an inference result on a display screen of the evaluation result information, and displaying only an inference result of which the likelihood is equal to or greater than the threshold as the inference result by the designated model on the display screen.

Thus, in a case where the inference result is displayed on the display screen of the test result, in a case where the performance of the designated model is low and the likelihood of the inference result is low, increasing the threshold makes it difficult to display the inference result. Conversely, in a case where the performance of the designated model is high and the likelihood of the inference result is high, the inference result is easily displayed without decreasing the threshold. By performing such control of display/non-display of the inference result according to a threshold of the likelihood, it is possible to enable the user to intuitively recognize whether or not the inference result with the likelihood desired by the user has been obtained by the display/non-display of the inference result, and it is possible to improve the grasping easiness of the test result.

Moreover, in the information processing apparatus as an embodiment, the inference target data is image data, the designated model is an AI model that performs, as the inference processing, object recognition processing including a task of detecting an object area, and the display processing unit performs processing of causing the user terminal device to display evaluation result information of inference performance by the evaluation unit, detection result information of the object area by the inference processing, and correct information thereof.

Thus, as the performance evaluation of the AI model that performs the class identification and the area detection on an object, not only an evaluation result regarding whether the class identification is correct or incorrect but also an evaluation result from the viewpoint of whether the object area has been correctly detected can be visually presented to the user. At this time, with respect to the evaluation result of object area detection, an error between the detection result information of the object area and the correct information thereof can be visually presented to the user, and the user can intuitively recognize an error between the detection area and a correct area.

Furthermore, in the information processing apparatus as an embodiment, the display processing unit is capable of selectively executing processing of causing the user terminal device to display evaluation result information by the evaluation unit and processing of causing the user terminal device to display visualized data of an inference processing result by the designated model.

Thus, even in a case where the inference task of the designated model is an inference task that cannot be evaluated and calculated, it is possible to display information indicating a test result.

Therefore, the correspondence range of the AI model capable of displaying the test result is widened, and the convenience of the user can be improved.

Moreover, in the information processing apparatus as an embodiment, the AI model is an AI model that performs inference processing on an image.

Thus, regarding the test of the AI model that performs the inference processing related to an image such as the object recognition processing, it is possible to improve the test accuracy and reduce the cost related to the test in a case where a test simulating the assumed use environment of the user is performed.

An information processing method as an embodiment is an information processing method including, by an information processing apparatus, causing an inference device that performs inference processing using an AI model to set a designated model that is an AI model designated by a user, and causing the inference device in a state in which the designated model has been set to execute inference processing using data designated by the user as inference target data.

Such an information processing method can produce functions and effects similar to the functions and effects produced by the information processing apparatus as the embodiment described above.

Here, as an embodiment, for example, a program for causing a CPU, a digital signal processor (DSP), or the like, or a device including the CPU, the DSP, or the like to execute the processing described above with reference to FIG. 20, FIG. 21, or the like, or a recording medium in which the program is recorded can be considered.

That is, the recording medium of the embodiment is a recording medium on which a program readable by a computer apparatus is recorded, the program causing the computer apparatus to implement a function of causing an inference device that performs inference processing using an AI model to set a designated model that is an AI model designated by a user, and a function of causing the inference device in a state in which the designated model has been set to execute inference processing using data designated by the user as inference target data.

With such a recording medium, a function for implementing the AI model test method as the above-described embodiment can be implemented by software processing in an apparatus as a computer apparatus.

The program described above can be recorded in advance in an HDD as a recording medium built in an apparatus such as a computer apparatus, ROM in a microcomputer including a CPU, or the like.

Alternatively, the removable recording medium may be a removable recording medium such as a flexible disk, a compact disc read only memory (CD-ROM), a magneto optical (MO) disk, a digital versatile disc (DVD), a Blu-ray disc (registered trademark), a magnetic disk, a semiconductor memory, or a memory card. Such a removable recording medium can be provided as so-called package software.

Furthermore, an inference device (8) as an embodiment includes an inference unit (AI processing unit 44) that performs inference processing using an AI model, and a control unit (81) that causes a designated model, which is an AI model designated by a user and transmitted from an external apparatus, to be set as the AI model used by the inference unit, and causes the inference unit in a state in which the designated model has been set to execute inference processing using data designated by the user and transmitted from the external apparatus as inference target data.

Even with such an inference device, it is possible to provide the user with an environment for testing the AI model using the inference device as an actual machine instead of a simulator as a test environment of the AI model. Furthermore, since the inference processing is executed on the data designated by the user, in order to implement a test simulating an assumed use environment as a test of the AI model, it is sufficient if the user prepares data acquired in the use environment in advance and designates the data, and it is not necessary to actually place the inference device under the assumed use environment or an environment simulating the assumed use environment at the time of the test.

Therefore, in a case where the AI model simulating the assumed use environment of the user is tested, it is possible to improve the test accuracy and reduce cost related to the test.

Furthermore, a control method as an embodiment is a control method in an inference device including an inference unit that performs inference processing using an AI model, the control method including causing a designated model, which is an AI model designated by a user and transmitted from an external apparatus, to be set as the AI model used by the inference unit, and causing the inference unit in a state in which the designated model has been set to execute inference processing using data designated by the user and transmitted from the external apparatus as inference target data.

By such a control method, it is also possible to obtain functions and effects similar to those of the inference device as the above-described embodiment.

Note that the effects described in the present specification are merely examples and are not restrictive, and other effects may also be produced.

### 5. Present Technology

The present technology can also adopt the following configurations.

(1)

An information processing apparatus including:
a setting control processing unit that causes an inference device that performs inference processing using an AI model to set a designated model that is an AI model designated by a user; and
an execution control processing unit that causes the inference device in a state in which the designated model has been set to execute inference processing using data designated by the user as inference target data.
   (2)

The information processing apparatus according to (1) described above, further including:
a conversion processing unit that converts data designated by the user into an input tensor data format of the designated model.
   (3)

The information processing apparatus according to (1) or (2) described above, further including:
an evaluation unit that receives inference result information by the designated model from the inference device and evaluates inference performance.
   (4)

The information processing apparatus according to (3) described above, in which
the evaluation unit evaluates the inference performance on the basis of correct data of inference designated by the user.
   (5)

The information processing apparatus according to (3) or (4) described above, further including:
a display processing unit that performs processing of displaying evaluation result information by the evaluation unit on a user terminal device that displays information for the user.
   (6)

The information processing apparatus according to (5) described above, in which
the display processing unit performs processing of displaying a designation reception unit that receives an operation of designating a threshold for likelihood of an inference result on a display screen of the evaluation result information, and displaying only an inference result of which the likelihood is equal to or greater than the threshold as the inference result by the designated model on the display screen.
   (7)

The information processing apparatus according to (5) or (6) described above, in which
the inference target data is image data,
the designated model is an AI model that performs, as the inference processing, object recognition processing including a task of detecting an object area, and
the display processing unit performs processing of causing the user terminal device to display evaluation result information of inference performance by the evaluation unit, detection result information of the object area by the inference processing, and correct information thereof.
   (8)

The information processing apparatus according to any one of (5) to (7) described above, in which
the display processing unit is capable of selectively executing processing of causing the user terminal device to display evaluation result information by the evaluation unit and processing of causing the user terminal device to display visualized data of an inference processing result by the designated model.
   (9)

The information processing apparatus according to any one of (1) to (8) described above, in which
the AI model is an AI model that performs inference processing on image data.
   (10)

An information processing method including:
by an information processing apparatus,
causing an inference device that performs inference processing using an AI model to set a designated model that is an AI model designated by a user; and
causing the inference device in a state in which the designated model has been set to execute inference processing using data designated by the user as inference target data.
   (11)

A recording medium on which a program readable by a computer apparatus is recorded, the program causing the computer apparatus to implement:
a function of causing an inference device that performs inference processing using an AI model to set a designated model that is an AI model designated by a user; and
a function of causing the inference device in a state in which the designated model has been set to execute inference processing using data designated by the user as inference target data.
   (12)

An inference device including:
an inference unit that performs inference processing using an AI model; and
a control unit that causes a designated model, which is an AI model designated by a user and transmitted from an external apparatus, to be set as the AI model used by the inference unit, and causes the inference unit in a state in which the designated model has been set to execute inference processing using data designated by the user and transmitted from the external apparatus as inference target data.
   (13)

A control method in an inference device including an inference unit that performs inference processing using an AI model, the control method including:
causing a designated model, which is an AI model designated by a user and transmitted from an external apparatus, to be set as the AI model used by the inference unit, and causing the inference unit in a state in which the designated model has been set to execute inference processing using data designated by the user and transmitted from the external apparatus as inference target data.

### REFERENCE SIGNS LIST

11, 11-1 CPU
17 Display unit
30 Image sensor
41 Imaging unit
42 Image signal processing unit
43 In-sensor control unit
44 AI processing unit
45 Memory unit
47 Communication interface
48 Bus
D1, D2 Die
8 Inference device
DF Device farm
81 Control unit
82 Communication unit
83 Bus
F1 Setting control processing unit
F2 Execution control processing unit
F3 Conversion processing unit
F4 Evaluation unit
F5 Display processing unit
Gs Setting screen
cb Check box
bsa Model designation box
bsi Image data designation box
bsg Correct data designation box
B1 Conversion instruction button
B2 Designation instruction button
Bs Execution button
Gr Test result screen
A3 Evaluation value display area
cb1, cb2, cb3, cb4 Check box
Art Inference result text display area
Ari Inference result image display area
B3 Forward feed button
B4 Reverse feed button
Pa Designation reception unit
Ma Designation operation element

1. An information processing apparatus comprising:
a setting control processing unit that causes an inference device that performs inference processing using an AI model to set a designated model that is an AI model designated by a user; and
an execution control processing unit that causes the inference device in a state in which the designated model has been set to execute inference processing using data designated by the user as inference target data.

2. The information processing apparatus according to claim 1, further comprising:
a conversion processing unit that converts data designated by the user into an input tensor data format of the designated model.

3. The information processing apparatus according to claim 1, further comprising:
an evaluation unit that receives inference result information by the designated model from the inference device and evaluates inference performance.

4. The information processing apparatus according to claim 3, wherein
the evaluation unit evaluates the inference performance on a basis of correct data of inference designated by the user.

5. The information processing apparatus according to claim 3, further comprising:
a display processing unit that performs processing of displaying evaluation result information by the evaluation unit on a user terminal device that displays information for the user.

6. The information processing apparatus according to claim 5, wherein
the display processing unit performs processing of displaying a designation reception unit that receives an operation of designating a threshold for likelihood of an inference result on a display screen of the evaluation result information, and displaying only an inference result of which the likelihood is equal to or greater than the threshold as the inference result by the designated model on the display screen.

7. The information processing apparatus according to claim 5, wherein
the inference target data is image data,
the designated model is an AI model that performs, as the inference processing, object recognition processing including a task of detecting an object area, and
the display processing unit performs processing of causing the user terminal device to display evaluation result information of inference performance by the evaluation unit, detection result information of the object area by the inference processing, and correct information thereof.

8. The information processing apparatus according to claim 5, wherein
the display processing unit is capable of selectively executing processing of causing the user terminal device to display the evaluation result information by the evaluation unit and processing of causing the user terminal device to display visualized data of an inference processing result by the designated model.

9. The information processing apparatus according to claim 1, wherein
the AI model is an AI model that performs inference processing on image data.

10. An information processing method comprising:
by an information processing apparatus,
causing an inference device that performs inference processing using an AI model to set a designated model that is an AI model designated by a user; and
causing the inference device in a state in which the designated model has been set to execute inference processing using data designated by the user as inference target data.

11. A recording medium on which a program readable by a computer apparatus is recorded, the program causing the computer apparatus to implement:
a function of causing an inference device that performs inference processing using an AI model to set a designated model that is an AI model designated by a user; and
a function of causing the inference device in a state in which the designated model has been set to execute inference processing using data designated by the user as inference target data.

12. An inference device comprising:
an inference unit that performs inference processing using an AI model; and
a control unit that causes a designated model, which is an AI model designated by a user and transmitted from an external apparatus, to be set as the AI model used by the inference unit, and causes the inference unit in a state in which the designated model has been set to execute inference processing using data designated by the user and transmitted from the external apparatus as inference target data.

13. A control method in an inference device including an inference unit that performs inference processing using an AI model, the control method comprising:
causing a designated model, which is an AI model designated by a user and transmitted from an external apparatus, to be set as the AI model used by the inference unit, and causing the inference unit in a state in which the designated model has been set to execute inference processing using data designated by the user and transmitted from the external apparatus as inference target data.
